(19) United States
(12) Patent Application Publication
(10) Pub. No.: US 2026/0365138 A1
(43) Pub. Date: Nov. 19, 2026

(54) VEHICLE SERVICE MANAGEMENT SYSTEM, VEHICLE SERVICE MANAGEMENT DEVICE, VEHICLE SERVICE MANAGEMENT METHOD, AND NON-TRANSITORY COMPUTER READABLE MEDIUM

(71) Applicant: NEC Corporation, Tokyo (JP)

(72) Inventor: Takatoshi KINO, Tokyo (JP)

(73) Assignee: NEC Corporation, Tokyo (JP)

(21) Appl. No.: 19/145,964

(22) PCT Filed: Mar. 28, 2023
(86) PCT No.: PCT/JP2023/012671

§ 371 Date: Jul. 7, 2025

(51) Int. Cl. B60R 25/01; G06Q 30/0283; G06Q 30/0645; G08B 21/24

(52) U.S. Cl. CPC B60R 25/01; G06Q 30/0284; G06Q 30/0645; G08B 21/24

(57) ABSTRACT

This vehicle service management system acquires use end information indicating that a user ends using a vehicle, detects an item left behind in the vehicle, performs a left-behind-item notification indicating the presence of a left-behind-item when the use end information is acquired and a left-behind-item is detected, acquires, as a response to the left-behind-item notification, a collection scheduled time indicating the time when the user will return to the parking location of the vehicle in order to collect the left-behind-item, and controls unlocking of the vehicle. The unlocking control of the vehicle includes permitting unlocking of the vehicle by the user on the basis of the collection scheduled time.

### TECHNICAL FIELD

The present invention relates to a vehicle service management system, a vehicle service management device, a vehicle service management method, and a recording medium.

### BACKGROUND ART

Services for a plurality of users to use a vehicle are generally used. For example, PTL 1 describes a shared vehicle system including an ETC in-vehicle device using an ETC card.

The shared vehicle system described in PTL 1 includes means for detecting whether use end operation for a shared vehicle is performed, and means for detecting whether an ETC card is inserted into the ETC in-vehicle device. The shared vehicle system described in PTL 1 invalidates completion of the use end operation of the shared vehicle if it is detected that the ETC card is inserted into the ETC in-vehicle device when it is detected that the use end operation of the shared vehicle is performed.

PTL 1 discloses issuing a warning by at least one of display or sound if it is detected that the ETC card is inserted into the ETC in-vehicle device when it is detected that the use end operation of the shared vehicle is performed. PTL 1 discloses notifying a communication device owned by a user of the shared vehicle after completion of the use end operation of the shared vehicle is invalidated.

### CITATION LIST

### Patent Literature

PTL 1: JP 2012-98909 A

### SUMMARY OF INVENTION

### Technical Problem

However, there is a possibility that the user does not notice the warning or notification described in PTL 1 and leaves the shared vehicle while leaving the ETC card behind in the shared vehicle. In such a case, even if the user notices that he or she has left the ETC card behind after leaving the shared vehicle, it may take time and effort to collect the ETC card.

What is left behind in the vehicle is not limited to the ETC card. With the technique described in PTL 1, it is difficult to handle left-behind articles other than the ETC card.

In view of the above-described problem, an object of the present invention is to provide a vehicle service management system, a vehicle service management device, a vehicle service management method, a recording medium, and the like, that enable a user to easily collect an article left behind in a vehicle in a case where the user has left the article behind in the vehicle.

### Solution to Problem

According to one aspect of the present invention,

a vehicle service management system is provided, the vehicle service management system including:

end information acquisition means for acquiring use end information indicating that a user ends use of a vehicle;

left-behind article detection means for detecting a left-behind article in the vehicle;

left-behind article notification means for making a left-behind article notification indicating that there is the left-behind article in a case where the use end information is acquired and the left-behind article is detected;

collection schedule acquisition means for acquiring scheduled collection time indicating time when the user will return to a parking place of the vehicle to collect the left-behind article as a response to the left-behind article notification; and

unlocking control means for controlling unlocking of the vehicle,

in which controlling unlocking of the vehicle includes allowing the user to unlock the vehicle based on the scheduled collection time.

According to one aspect of the present invention,

a vehicle service management device is provided, the vehicle service management device including:

end information acquisition means for acquiring use end information indicating that a user ends use of a vehicle;

detection information acquisition means for acquiring detection information indicating that a left-behind article is detected in the vehicle;

left-behind article notification means for making a left-behind article notification indicating that there is the left-behind article in a case where the use end information is acquired and the detection information is acquired;

collection schedule acquisition means for acquiring scheduled collection time indicating time when the user will return to a parking place of the vehicle to collect the left-behind article as a response to the left-behind article notification; and

vehicle instruction means for transmitting an unlocking control instruction for controlling unlocking of the vehicle,

in which the unlocking control instruction includes an instruction for allowing the user to unlock the vehicle based on the scheduled collection time.

According to one aspect of the present invention,

a vehicle service management method to be executed by one or more computers is provided, the vehicle service management method including:

acquiring use end information indicating that a user ends use of a vehicle;

detecting a left-behind article in the vehicle;

making a left-behind article notification indicating that there is the left-behind article in a case where the use end information is acquired and the left-behind article is detected;

acquiring scheduled collection time indicating time when the user will return to a parking place of the vehicle to collect the left-behind article as a response to the left-behind article notification; and

controlling unlocking of the vehicle,

in which the controlling unlocking of the vehicle includes allowing the user to unlock the vehicle based on the scheduled collection time.

According to one aspect of the present invention,

a recording medium recording a program for causing one or more computers to execute:

acquiring use end information indicating that a user ends use of a vehicle;

detecting a left-behind article in the vehicle;

making a left-behind article notification indicating that there is the left-behind article in a case where the use end information is acquired and the left-behind article is detected;

acquiring scheduled collection time indicating time when the user will return to a parking place of the vehicle to collect the left-behind article as a response to the left-behind article notification; and

controlling unlocking of the vehicle,

in which the controlling unlocking of the vehicle includes allowing the user to unlock the vehicle based on the scheduled collection time.

### Advantageous Effects of Invention

According to one aspect of the present invention, in a case where a user has left an article behind in a vehicle, it is possible for the user to easily collect the left-behind article.

### BRIEF DESCRIPTION OF DRAWINGS

FIG. 1 is a view illustrating outline of a vehicle service management system according to a first example embodiment.

FIG. 2 is a view illustrating outline of a vehicle service management device according to the first example embodiment.

FIG. 3 is a flowchart indicating an example of first vehicle service management processing.

FIG. 4 is a flowchart indicating an example of second vehicle service management processing.

FIG. 5 is a view illustrating a configuration example of the vehicle service management system according to the first example embodiment.

FIG. 6 is a view illustrating a functional configuration example of the vehicle service management device according to the first example embodiment.

FIG. 7 is a view indicating an example of user data.

FIG. 8 is a view indicating an example of use schedule data.

FIG. 9 is a view illustrating a functional configuration example of a user terminal according to the first example embodiment.

FIG. 10 is a view illustrating a functional configuration example of an in-vehicle device according to the first example embodiment.

FIG. 11 is a view illustrating a physical configuration example of a management device according to the first example embodiment.

FIG. 12 is a view illustrating a physical configuration example of the user terminal according to the first example embodiment.

FIG. 13 is a view illustrating a physical configuration example of the in-vehicle device according to the first example embodiment.

FIG. 14 is a view indicating an example of flow of user management processing according to the first example embodiment.

FIG. 15 is a view indicating an example of flow of use schedule management processing according to the first example embodiment.

FIG. 16 is a view indicating an example of flow of use start processing according to the first example embodiment.

FIG. 17 is a view indicating an example of flow of use end processing according to the first example embodiment.

FIG. 18 is a view indicating an example of flow of the use end processing according to the first example embodiment.

FIG. 19 is a view illustrating a functional configuration example of a management device according to a second example embodiment.

FIG. 20 is a view illustrating a functional configuration example of an in-vehicle device according to the second example embodiment.

FIG. 21 is a view indicating an example of flow of use end processing according to the second example embodiment.

FIG. 22 is a view illustrating a functional configuration example of a management device according to a third example embodiment.

FIG. 23 is a view illustrating a functional configuration example of a delivery request unit according to the third example embodiment.

FIG. 24 is a view illustrating a functional configuration example of a user terminal according to the third example embodiment.

FIG. 25 is a view illustrating a functional configuration example of an in-vehicle device according to the third example embodiment.

FIG. 26 is a view indicating an example of flow of use end processing according to the third example embodiment.

FIG. 27 is a view indicating an example of flow of first left-behind article handling processing according to the third example embodiment.

FIG. 28 is a view indicating an example of flow of third left-behind article handling processing according to the third example embodiment.

FIG. 29 is a view indicating an example of flow of fourth left-behind article handling processing according to the third example embodiment.

FIG. 30 is a view indicating an example of flow of second left-behind article handling processing according to the third example embodiment.

FIG. 31 is a view indicating an example of flow of fifth left-behind article handling processing according to the third example embodiment.

FIG. 32 is a view indicating an example of flow of sixth left-behind article handling processing according to the third example embodiment.

FIG. 33 is a view illustrating a functional configuration example of a management device according to a fourth example embodiment.

FIG. 34 is a view illustrating a functional configuration example of a contact unit according to the fourth example embodiment.

FIG. 35 is a view illustrating a functional configuration example of a user terminal according to the fourth example embodiment.

FIG. 36 is a view indicating an example of flow of fifth left-behind article handling processing according to the fourth example embodiment.

FIG. 37 is a view indicating an example of flow of first response handling processing according to the fourth example embodiment.

### EXAMPLE EMBODIMENT

Hereinafter, example embodiments of the present invention will be described with reference to the drawings. In all the drawings, the same components are denoted by the same reference numerals, and the description thereof will be omitted as appropriate.

### First Example Embodiment

### Outline

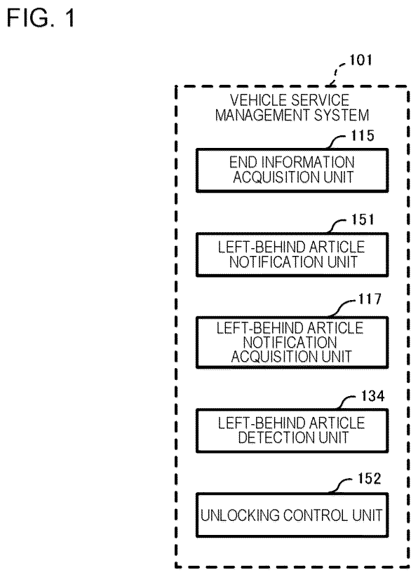

FIG. 1 is a view illustrating outline of a vehicle service management system 100 according to a first example embodiment. The vehicle service management system 100 includes an end information acquisition unit 115, a left-behind article detection unit 151, a left-behind article notification unit 117, a collection schedule acquisition unit 118, and an unlocking control unit 152.

The end information acquisition unit 115 acquires use end information indicating that a user ends use of a vehicle.

The left-behind article detection unit 151 detects an article left behind in the vehicle.

The left-behind article notification unit 117 make a left-behind article notification indicating that there is the left-behind article in a case where the use end information is acquired and the left-behind article is detected.

The collection schedule acquisition unit 118 acquires scheduled collection time indicating time when the user will return to a parking place of the vehicle to collect the left-behind article as a response to the left-behind article notification.

The unlocking control unit 152 controls unlocking of the vehicle.

The unlocking control of the vehicle includes allowing the user to unlock the vehicle based on the scheduled collection time.

According to the vehicle service management system 100, in a case where an article is left behind in the vehicle, the user can easily collect the left-behind article.

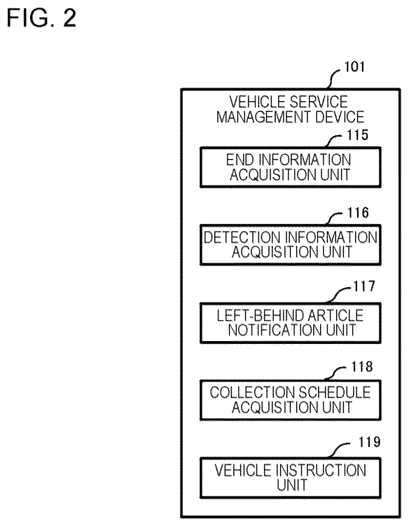

FIG. 2 is a view illustrating outline of a vehicle service management device 101 according to the first example embodiment. The vehicle service management device 101 includes an end information acquisition unit 115, a detection information acquisition unit 116, a detection information acquisition unit 116, a left-behind article notification unit 117, a collection schedule acquisition unit 118, and a vehicle instruction unit 119.

The end information acquisition unit 115 acquires use end information indicating that the user ends use of the vehicle.

The detection information acquisition unit 116 acquires detection information indicating that a left-behind article has been detected in the vehicle.

The left-behind article notification unit 117 makes a left-behind article notification indicating that there is the left-behind article in a case where the use end information is acquired and the left-behind article is detected.

The collection schedule acquisition unit 118 acquires scheduled collection time indicating time when the user will return to a parking place of the vehicle to collect the left-behind article as a response to the left-behind article notification.

The vehicle instruction unit 119 transmits an unlocking control instruction for controlling unlocking of the vehicle.

The unlocking control instruction includes an instruction for allowing the user to unlock the vehicle based on the scheduled collection time.

According to the vehicle service management device 101, in a case where the user has left an article behind in the vehicle, the user can easily collect the left-behind article.

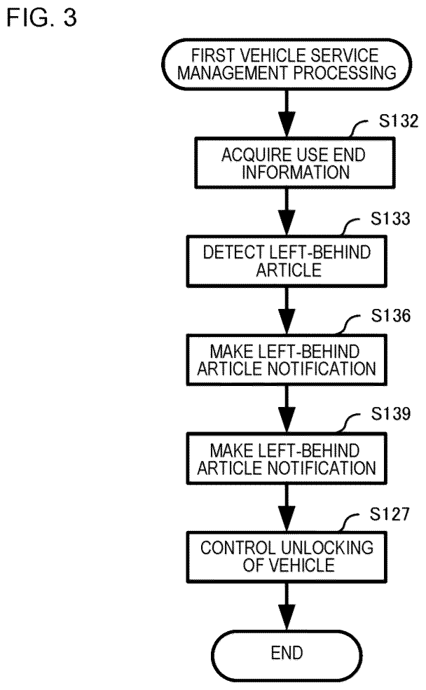

FIG. 3 is a flowchart indicating an example of first vehicle service management processing.

The end information acquisition unit 115 acquires use end information indicating that the user ends use of the vehicle (step S132).

The left-behind article detection unit 151 detects a left-behind article in the vehicle (step S133).

The left-behind article notification unit 117 makes a left-behind article notification indicating that there is the left-behind article in a case where the use end information is acquired and the left-behind article is detected (step S136).

The collection schedule acquisition unit 118 acquires scheduled collection time indicating time when the user will return to a parking place of the vehicle to collect the left-behind article as a response to the left-behind article notification (step S139).

The unlocking control unit 152 controls unlocking of the vehicle (step S127).

The unlocking control of the vehicle includes allowing the user to unlock the vehicle based on the scheduled collection time.

According to the first vehicle service management processing, in a case where the user has left an article behind in the vehicle, the user can easily collect the left-behind article.

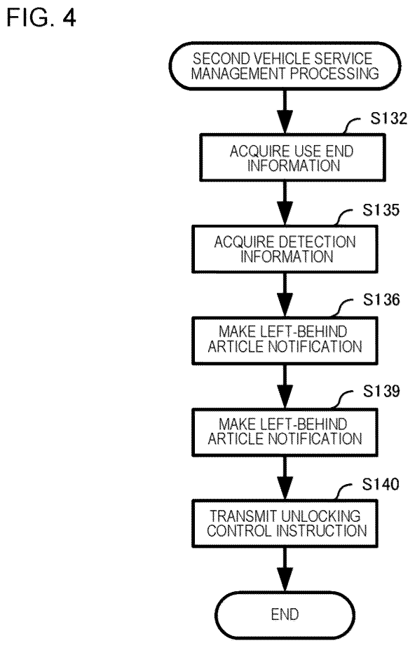

FIG. 4 is a flowchart indicating an example of second vehicle service management processing.

The end information acquisition unit 115 acquires use end information indicating that the user ends use of the vehicle (step S132).

The detection information acquisition unit 116 acquires detection information indicating that a left-behind article has been detected in the vehicle (step S135).

In a case where the use end information is acquired and the detection information is acquired, the left-behind article notification unit 117 transmits a left-behind article notification indicating that there is the left-behind article (step S136).

The collection schedule acquisition unit 118 acquires scheduled collection time indicating time when the user will return to a parking place of the vehicle to collect the left-behind article as a response to the left-behind article notification (step S139).

The vehicle instruction unit 119 transmits an unlocking control instruction for controlling unlocking of the vehicle (step S140).

The unlocking control instruction includes an instruction for allowing the user to unlock the vehicle based on the scheduled collection time.

According to the second vehicle service management processing, in a case where the user has left an article behind in the vehicle, the user can easily collect the left-behind article.

Hereinafter, a detailed example of the vehicle service management system 100 according to the first example embodiment will be described.

### Details

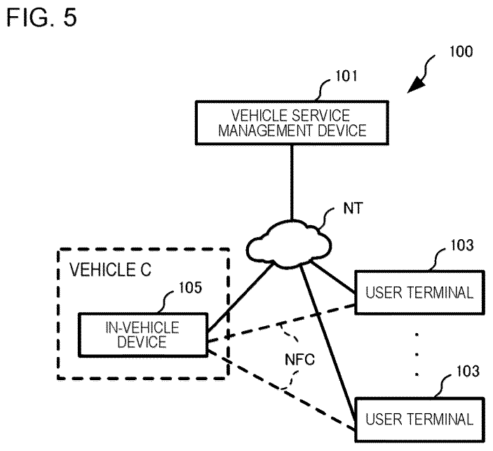

FIG. 5 is a view illustrating a configuration example of the vehicle service management system 100 according to the first example embodiment. The vehicle service management system 100 is a system for managing a vehicle service. Hereinafter, the vehicle service management system is also simply referred to as a “management system”.

The vehicle service is a service for a plurality of users to use a vehicle. In the vehicle service, one or more vehicles are provided to be scheduled to be used by a plurality of users.

Such a vehicle service is typically a service generally referred to as car sharing (service), car sharing (service), or the like, but is not limited thereto. The vehicle service may be, for example, a service for a plurality of users to use a vehicle owned by a predetermined group or individual. Specifically, for example, the vehicle service may be a service for allowing a plurality of users to use a vehicle owned by a car rental company, a service for allowing a plurality of staff members to use a vehicle owned by a company, a local government, or the like. The present invention is applicable to such various kinds of vehicle services.

Hereinafter, a “user” means a user of the vehicle service. A “vehicle” is a vehicle to be used to provide the vehicle service.

As illustrated in FIG. 5, the management system 100 includes the vehicle service management device 101, a plurality of user terminals 103 to be used by a plurality of users, and an in-vehicle device 105 mounted on the vehicle. A vehicle C in the drawing is an example of the vehicle.

The vehicle service management device 101, each of the user terminals 103, and the in-vehicle device 105 are connected to each other via a network NT, and transmit and receive information to and from each other via the network NT. The network NT is a communication line configured in a wired manner, a wireless manner, or a combination thereof. For example, the network NT preferably at least partially includes a wireless communication line in order to connect the in-vehicle device 105, the mobile user terminals 103, and the like.

Each of the user terminals 103 and the in-vehicle device 105 are connected to each other via near field communication NFC within a predetermined distance, and transmit and receive information to and from each other via the near field communication NFC.

It is only necessary to provide one or more user terminals 103. The user terminal 103 is not limited to a mobile terminal, and may be an installation type terminal.

### Functional Configuration Example of Vehicle Service Management Device 101 According to First Example Embodiment

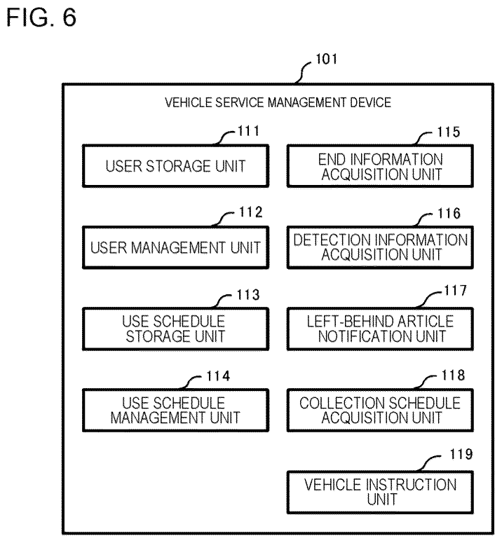

FIG. 6 is a view illustrating a functional configuration example of the vehicle service management device 101 according to the first example embodiment. The vehicle service management device 101 is a device for managing the vehicle service. Hereinafter, the vehicle service management device is also simply referred to as a “management device”.

The management device 101 functionally includes, for example, a user storage unit 111, a user management unit 112, a use schedule storage unit 113, a use schedule management unit 114, an end information acquisition unit 115, a detection information acquisition unit 116, a left-behind article notification unit 117, a collection schedule acquisition unit 118, and a vehicle instruction unit 119.

The user storage unit 111 is a storage unit for storing user data 111a. The user data 111a is data related to the user. For example, in a case where the user uses the vehicle service, the user is registered in the user data 111a in advance.

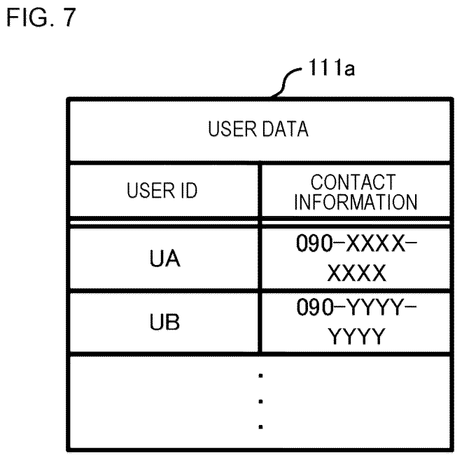

FIG. 7 is a view indicating an example of the user data 111a.

The user data 111a associates, for example, a user identification (ID) and contact information. The user ID is information for identifying each of the users. The contact information is information indicating the contact information of the user.

For example, the user data 111a indicated in the drawing includes data indicating that a phone number as the contact information of a user whose user ID is “UA” is “090-XXXX-XXXX”. The phone number is desirably a phone number that can be contacted by a terminal (for example, the user terminal 103, or the like) carried by the user.

The user data 111a is not limited thereto. For example, the user data 111a may include one or more of a user ID, a user terminal ID, contact information, a user name, an address, payment information, and the like. The user terminal ID is information for identifying each of the user terminals 103. The information for identifying the user is not limited to the user terminal ID, and may be one or more pieces of information such as the user terminal ID, the contact information, and the user terminal ID. The contact information may be, for example, one or more of a phone number, an e-mail address, an ID on a social networking service (SNS) to be used by the user, and the like.

Reference is made again to FIG. 6.

The user management unit 112 performs processing for managing the user.

For example, the user management unit 112 manages the user data 111a based on the user information. The user information is information regarding the user, and includes, for example, contact information input by the user, or the like. The management of the user data 111a may include one or more of newly registering a user in the user data 111a, updating the user data 111a related to an already registered user, and the like.

The use schedule storage unit 113 is a storage unit for storing use schedule data 113a.

The use schedule data 113a is data indicating a use schedule related to the vehicle. Hereinafter, the “use schedule” means a use schedule related to the vehicle.

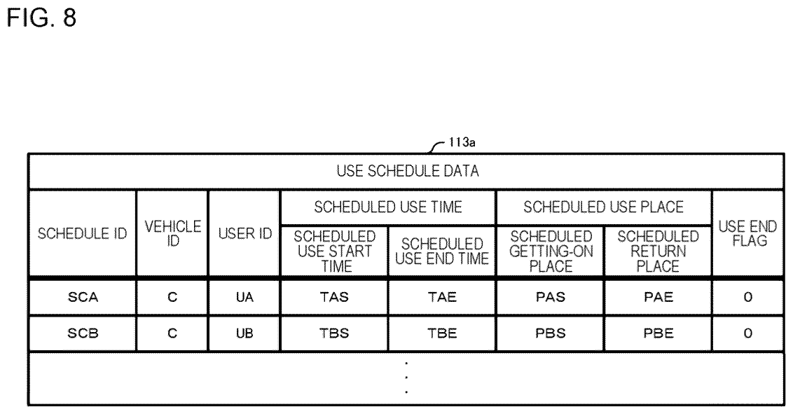

FIG. 8 is a view indicating an example of the use schedule data 113a.

The use schedule data 113a associates, for example, a schedule ID, a vehicle ID, a user ID, scheduled use time, a scheduled use place, and a use end flag.

The schedule ID is information for identifying each of the use schedules.

The vehicle ID is information for identifying the vehicle.

The user ID corresponds to the user ID included in the user data 111a. The user data 111a and the use schedule data 113a can be associated with each other using the user ID.

The scheduled use time is information indicating scheduled use time of the vehicle. The scheduled use time includes, for example, scheduled use start time and scheduled use end time. The scheduled use start time is scheduled time when the use of the vehicle is to be started. The scheduled use end time is scheduled time when the use of the vehicle is to end. These kinds of time are represented by, for example, a combination of year, month, date and time, but are not limited thereto.

The scheduled use place is information on a scheduled place where the vehicle is to be used. The scheduled use place includes, for example, a scheduled getting-on place and a scheduled return place. The scheduled getting-on place is a scheduled place where the use of the vehicle is to be started. The scheduled return place is a scheduled place where the use of the vehicle is to end.

The scheduled getting-on place and the scheduled return place are, for example, places selected by the user from a plurality of places such as a parking lot designated by the vehicle service according to the user's desire.

The use end flag is a flag indicating that the use of the vehicle scheduled in the use schedule ends. In the use end flag in the drawing, “0” indicates that the use of the vehicle associated with the use end flag is not completed, and “1” is set when the use ends.

The use schedule data 113a is not limited thereto. For example, as a use condition of the vehicle service, it may be determined that the scheduled getting-on place and the scheduled return place are a common place, and the use place information in such a case may be one piece of information indicating the common place. The use end flag is not limited to “0” or “1”, and other methods may be used.

Reference is made again to FIG. 6.

The use schedule management unit 114 performs processing for managing a use schedule based on reservation information for the user to reserve the vehicle.

For example, the use schedule management unit 114 manages the use schedule data 113a based on the reservation information.

For example, the reservation information includes one or more pieces of reservation application information, reservation update information, and the like.

The reservation application information is information for the user to newly reserve the vehicle. The reservation update information is information for the user to change the already reserved content of the reserved vehicle.

The use schedule management unit 114 generates the use schedule data 113a indicating a new use schedule based on the reservation application information. Then, a schedule registration unit 114a stores the generated use schedule data 113a in the use schedule storage unit 113.

The use schedule management unit 114 updates the use schedule data 113a stored in the use schedule storage unit 113 based on the reservation update information.

The end information acquisition unit 115 acquires use end information.

The use end information is information indicating that the user ends use of the vehicle. The use end information includes, for example, at least one of the user ID or the vehicle ID for identifying the user or the vehicle.

If the use end information is acquired, the end information acquisition unit 115 may set “1” in the use end flag of the use schedule data 113a related to the acquired use end information.

The detection information acquisition unit 116 acquires detection information. The detection information is information indicating that a left-behind article has been detected in the vehicle.

The left-behind article is an article left behind in the vehicle after the use of the vehicle ends, and is, for example, an ETC card. The ETC card is a card for using an electronic toll collection system (ETC).

The left-behind article notification unit 117 makes a left-behind article notification. The left-behind article notification is a notification indicating that there is the left-behind article in the vehicle.

In the present example embodiment, the left-behind article notification unit 117 makes the left-behind article notification in a case where the use end information and the detection information are acquired by the end information acquisition unit 115 and the detection information acquisition unit 116, respectively.

For example, the left-behind article notification unit 117 makes a left-behind article notification to the user terminal 103 of the user who has left the article behind in the vehicle. The user who has left the article behind is, for example, a user who has used the vehicle most recently in a case where the left-behind article is detected in the vehicle. Such a user may be specified using the use end information acquired by the end information acquisition unit 115.

The collection schedule acquisition unit 118 acquires scheduled collection time as a response to the left-behind article notification transmitted by the left-behind article notification unit 117. The scheduled collection time is information indicating time when the user who has left the article behind will return to a return place of the vehicle to collect the left-behind article. The time is represented by using, for example, one or more of year, month and date, time, hours, and the like, but is not limited thereto.

The return place is a place where the user has returned the vehicle, and is typically the scheduled return place. However, in a case where the user has changed the schedule, the return place may be a place different from the scheduled return place. The return place in this case may be any of places designated in the vehicle service, similarly to the scheduled return place.

The vehicle instruction unit 119 transmits an unlocking control instruction for controlling unlocking of the vehicle. The unlocking control instruction is, for example, an instruction for allowing a specific user to unlock the vehicle at specific time.

The unlocking control instruction is transmitted in accordance with reservation of the vehicle by the user and collection of the left-behind article.

For example, the unlocking control instruction according to the reservation of the vehicle is an instruction for allowing the user who has reserved the vehicle to unlock the vehicle from allowable start time determined based on the scheduled use start time. In this case, the allowable start time may be the scheduled use start time, a predetermined period (for example, five minutes) before the scheduled use start time, or the like.

For example, the unlocking control instruction according to the collection of the left-behind article is an instruction for allowing the user who has left the article behind in the vehicle to unlock the vehicle from the allowable start time determined based on the scheduled collection time. The allowable start time in this case may be the scheduled collection time, a predetermined period (for example, five minutes) before the scheduled collection time, or the like, as described above. In a case where the allowable start time is time a predetermined period before the scheduled collection time, the predetermined period may be different or the same between the unlocking control instruction according to the reservation of the vehicle and the unlocking control instruction according to the collection of the left-behind article.

### Functional Configuration Example of User Terminal 103 According to First Example Embodiment

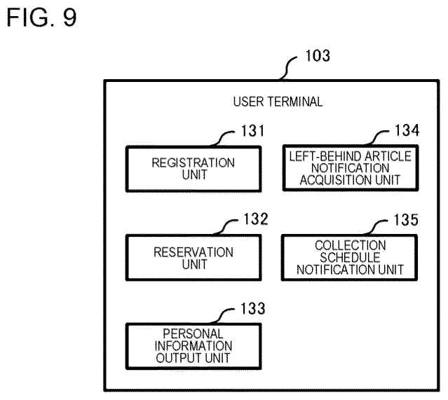

FIG. 9 is a view illustrating a functional configuration example of the user terminal 103 according to the first example embodiment. Each of the user terminals 103 according to the present example embodiment is a mobile terminal owned by the user, and is, for example, a smartphone, a tablet terminal, or the like.

Each of the user terminals 103 preferably has a similar function. Thus, here, a functional configuration will be described using one of the plurality of user terminals 103 as an example.

The user terminal 103 functionally includes, for example, a registration unit 131, a reservation unit 132, a personal information output unit 133, a left-behind article notification acquisition unit 134, and a collection schedule notification unit 135.

The registration unit 131 transmits user information based on, for example, a user input.

The reservation unit 132 generates reservation information based on, for example, a user input, and transmits the generated reservation information.

If the user performs predetermined operation in a case where the user starts or ends use of the reserved vehicle, in a case where the user collects the left-behind article in the vehicle, or the like, the personal information output unit 133 outputs personal information using, for example, the near field communication NFC.

The personal information is information for confirming that the user is the user himself/herself who has reserved the vehicle or the user himself/herself has left the article behind in the vehicle. The personal information includes, for example, the user ID. The personal information is not limited thereto, and may be, for example, a reservation number issued at the time of reservation.

For example, if predetermined operation is accepted from the user and a distance between the user terminal 103 and the in-vehicle device 105 is within a predetermined distance, the personal information output unit 133 performs near field communication NFC with the in-vehicle device 105. The personal information output unit 133 transmits the personal information to the in-vehicle device 105 using the near field communication NFC.

The left-behind article notification acquisition unit 134 acquires the left-behind article notification.

The collection schedule notification unit 135 transmits the scheduled collection time, for example, based on a user input.

### Functional Configuration Example of In-vehicle Device 105 According to First Example Embodiment

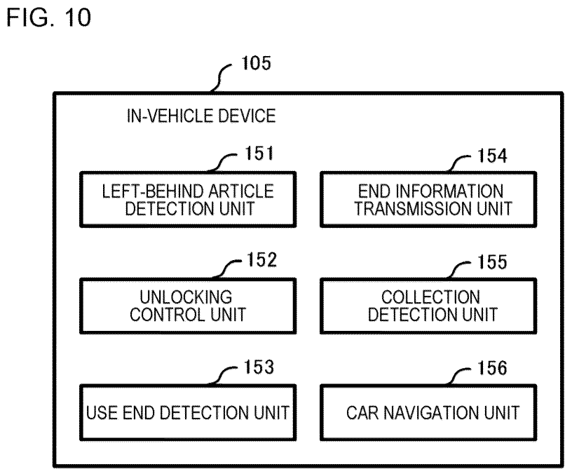

FIG. 10 is a view illustrating a functional configuration example of the in-vehicle device 105 according to the first example embodiment. The in-vehicle device 105 functionally includes, for example, a left-behind article detection unit 151, an unlocking control unit 152, a use end detection unit 153, an end information transmission unit 154, a collection detection unit 155, and a car navigation unit 156.

The left-behind article detection unit 151 detects a left-behind article in the vehicle.

For example, the left-behind article detection unit 151 includes one or more sensors that acquire information for detecting a left-behind article in the vehicle. Examples of the sensors include an electronic toll collection system (ETC) device and a camera.

The ETC device is a device for using the ETC. In a case where the user of the vehicle uses the ETC, an ETC card is attached to the ETC device. If the ETC card that is a recording medium is attached, the ETC device detects the ETC card. Then, the ETC device reads information recorded in the ETC card, and performs processing for using the ETC by using the read information.

In a case where the left-behind article detection unit 151 includes the ETC device, the left-behind article detection unit 151 preferably acquires, for example, information indicating that the ETC card is attached to the ETC device from the ETC device, and detects that the ETC card is in the vehicle as a left-behind article.

The ETC device is an example of a device (vehicle installation device) installed in the vehicle and used by connecting a recording medium, a terminal, and the like. The recording medium, the terminal, and the like, are typically owned by the user, and a method of connecting these to the vehicle installation device may be contact between terminals by attachment, wired connection using a cable, or wireless connection. For example, the vehicle installation device is not limited to the ETC card, and may be a card reading device to which a card medium such as a member card or a credit card is attached and which reads information from the card medium. For example, the vehicle installation device may be a device to which a recording medium such as a universal serial bus (USB) storage or a memory card (for example, an SD memory card) is attached and which reads information from the recording medium. For example, the vehicle installation device may be a device that operates by a terminal such as a smartphone or a tablet terminal being connected in a wired or wireless manner, and information being mutually transmitted and received with the connected terminal. The vehicle installation device is not limited to a device installed inside the vehicle, and may be a device installed outside the vehicle such as an antenna device.

In a case where the left-behind article detection unit 151 includes a camera, the camera captures an image of the inside of the vehicle, for example. The left-behind article detection unit 151 analyzes the image of the inside of the vehicle captured by the camera to detect a left-behind article in the vehicle.

A general technique may be used for image analysis for detecting a left-behind article in the vehicle, and for example, comparison of images, a machine learning model, or the like, may be used.

In a case where images are compared, for example, the left-behind article detection unit 151 may compare an image of the inside of the vehicle where there is no left-behind article and the image captured by the camera to obtain a degree of similarity between the images, and may detect a left-behind article in the vehicle based on a result of the comparison between the degree of similarity and a predetermined threshold.

In a case where the machine learning model is used, for example, the left-behind article detection unit 151 may detect a left-behind article in the vehicle by inputting the image captured by the camera to a machine learning model that has learned to detect an object based on the input image. In the learning of the machine learning model, for example, it is preferable to use teacher data including a learning image obtained by capturing an image of the inside of the vehicle and a correct answer label indicating a left-behind article included in the learning image.

The processing for detecting a left-behind article using the sensor and information acquired by the sensor is not limited thereto. For example, in order for the left-behind article detection unit 151 to detect an object attached to the outside of the vehicle, the camera may be provided to capture an image of an outer surface of the vehicle. For example, the sensor may be a sensor attached in the dashboard in order to detect a left-behind article in the dashboard.

The unlocking control unit 152 controls unlocking of the vehicle in accordance with the unlocking control instruction.

For example, the unlocking control unit 152 normally prohibits all users from unlocking the vehicle.

If the unlocking control instruction is acquired, the unlocking control unit 152 allows unlocking of the vehicle in accordance with the acquired unlocking control instruction. In a case where unlocking of the vehicle is allowed, if personal information indicating the user specified by the unlocking control instruction is acquired, the vehicle is unlocked.

The personal information is acquired from the user terminal 103 using the near field communication NFC, for example. A method for acquiring the personal information is not limited thereto, and for example, the personal information may be acquired by the user inputting the personal information to the in-vehicle device 105. In this case, the in-vehicle device 105 may include an input unit (not illustrated) for inputting personal information from outside the vehicle.

The unlocking control unit 152 continues unlocking the vehicle until a use end detection unit 153 to be described later detects end of the use of the vehicle or a collection detection unit 155 detects collection of the left-behind article.

The use end detection unit 153 detects that the user ends use of the vehicle based on the reservation.

There are various methods for detecting end of use of the vehicle.

For example, the use end detection unit 153 may detect end of use of the vehicle based on operation of the user or by acquiring predetermined information based on operation of the user from the user terminal 103. The use end detection unit 153 may detect end of use of the vehicle by acquiring the personal information indicating the user who has used the vehicle based on the reservation from the user terminal 103 using the near field communication NFC. A method of detecting end of use of the vehicle is not limited thereto.

If the use of the vehicle ends, the end information transmission unit 154 transmits the use end information.

The end information transmission unit 154 may be provided in the user terminal 103, and may transmit the use end information based on predetermined operation by the user.

The collection detection unit 155 detects that the left-behind article in the vehicle is collected.

There are various methods for detecting collection of the left-behind article.

For example, the collection detection unit 155 may detect that the left-behind article is collected in a case where the left-behind article detection unit 151 does not detect the left-behind article. For example, the collection detection unit 155 may detect that the left-behind article is collected based on operation of the user or by acquiring predetermined information based on operation of the user from the user terminal 103. For example, the collection detection unit 155 may detect that the left-behind article is collected by acquiring the personal information indicating the user who has left the article behind from the user terminal 103 using the near field communication NFC. A method of detecting collection of the left-behind article is not limited thereto.

The car navigation unit 156 guides the user to travel of the vehicle C. The car navigation unit 156 has at least one of a display function or a speech output function. The car navigation unit 156 having the display function may display, for example, a current position of the vehicle C, a position of a facility, a road, a route from the current position to a destination, and the like, on a map. The car navigation unit 156 having the speech output function may output, for example, a speech for conveying various types of information such as travel guidance to the user.

The functional configuration example of the management system 100 has been mainly described above. Hereinafter, a physical configuration example of the management system 100 will be described.

### Physical Configuration Example of Vehicle Service Management System 100 According to First Example Embodiment

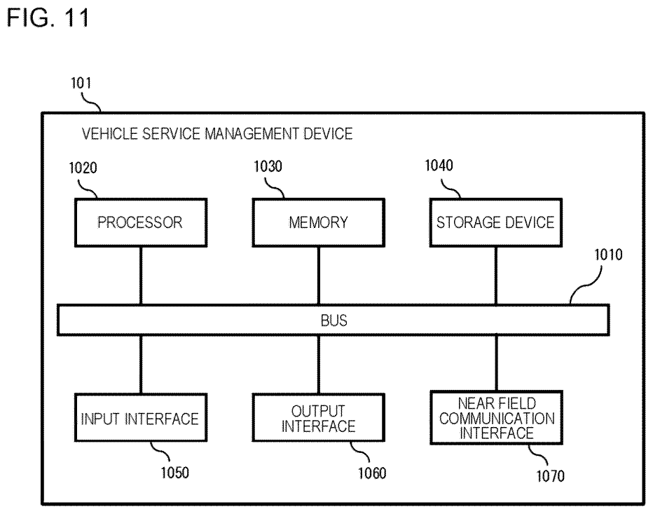

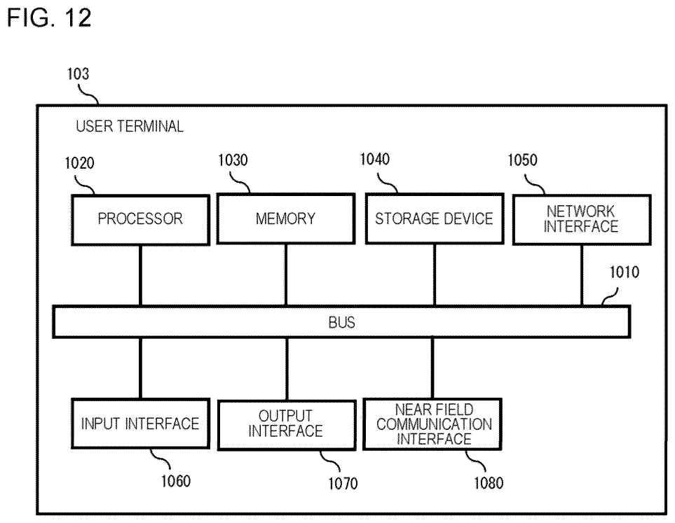

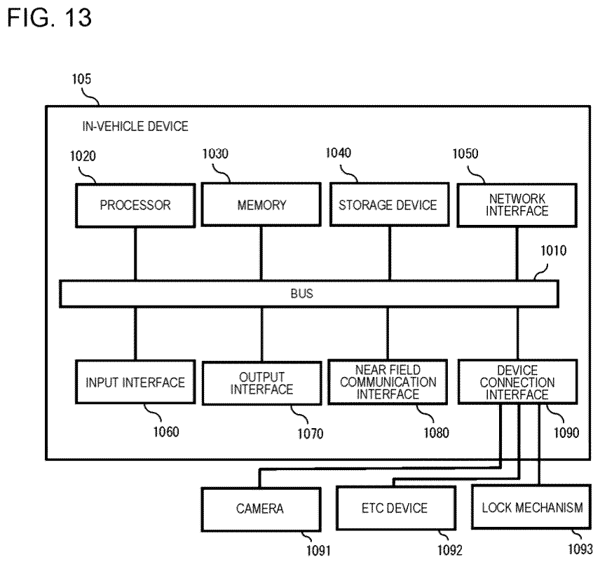

FIG. 11 is a view illustrating a physical configuration example of the management device 101 according to the first example embodiment. FIG. 12 is a view illustrating a physical configuration example of the user terminal 103 according to the first example embodiment. FIG. 13 is a view illustrating a physical configuration example of the in-vehicle device 105 according to the first example embodiment.

Each of the management device 101, the user terminal 103, and the in-vehicle device 105 includes a bus 1010, a processor 1020, a memory 1030, a storage device 1040, a network interface 1050, an input interface 1060, and an output interface 1070. Each of the user terminal 103 and the in-vehicle device 105 further includes a near field communication interface 1080. The in-vehicle device 105 further includes a device connection interface 1090.

The bus 1010 is a data transmission path through which the processor 1020, the memory 1030, the storage device 1040, the network interface 1050, the input interface 1060, and the output interface 1070 transmit and receive data to and from each other. However, a method of connecting the processor 1020, and the like, to each other is not limited to connection with the bus.

The processor 1020 is a processor to be implemented by a central processing unit (CPU), a graphics processing unit (GPU), or the like.

The memory 1030 is a main storage device to be implemented by a random access memory (RAM), or the like.

The storage device 1040 is an auxiliary storage device to be implemented by a hard disk drive (HDD), a solid state drive (SSD), a memory card, a read only memory (ROM), or the like. The storage device 1040 stores a program module for implementing a function of a device including the storage device. The processor 1020 reads and executes each program module in the memory 1030, thereby implementing the function related to the program module.

The network interface 1050 is an interface for connecting a device including the network interface to the network NT.

The input interface 1060 is an interface for the user to input information. The input interface 1060 includes, for example, a touch panel, a keyboard, a mouse, and the like.

The output interface 1070 is an interface for presenting information to the user. The output interface 1070 includes, for example, a liquid crystal panel, an organic electro-luminescence (EL) panel, and the like.

The near field communication interface 1080 is an interface for transmitting and receiving information using the near field communication NFC, and is connected to the bus 1010.

The device connection interface 1090 is an interface for transmitting and receiving information to and from other devices, and is connected to the bus 1010. The device connection interface 1090 may be an interface that uses either wired or wireless to connect to other devices.

FIG. 13 illustrates an example in which a camera 1091, an ETC device 1092, and a lock mechanism 1093 are connected to the device connection interface 1090.

Each of the camera 1091 and the ETC device 1092 is an example of a sensor constituting the left-behind article detection unit 151. The lock mechanism 1093 is a mechanism for mechanically or electromagnetically controlling unlocking and locking of a lock, for example. A method of controlling the lock is not limited to the mechanical or electromagnetic method, and may be appropriately changed.

Each of the management device 101 and the user terminal 103 may physically include a plurality of devices. Each of the plurality of devices in this case may physically include the components 1010 to 1070 illustrated in FIGS. 11 to 12. The in-vehicle device 105 may physically include a plurality of devices. Each of the plurality of devices in this case may physically include the components 1010 to 1090 illustrated in FIG. 13.

The configuration example of the management system 100 according to the first example embodiment has been mainly described above. An operation example of the management system 100 according to the first example embodiment will be described below.

The management system 100 executes vehicle service management processing. The vehicle service processing includes user management processing, use schedule management processing, use start processing, and use end processing.

### Example of User Management Processing According to First Example Embodiment

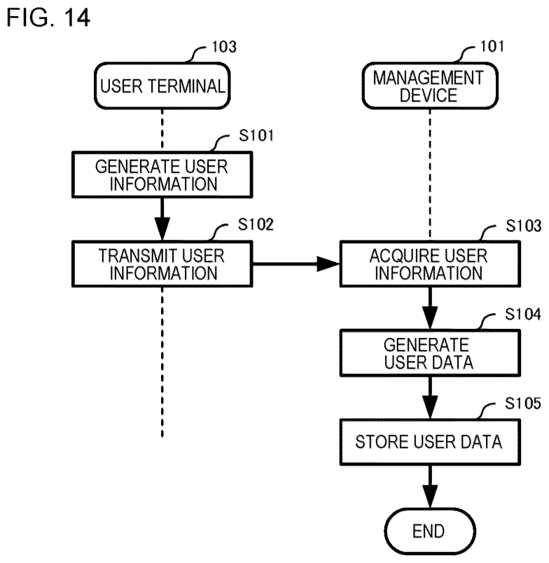

FIG. 14 is a view indicating an example of flow of the user management processing according to the first example embodiment. The user management processing is processing for managing the user of the vehicle service. The user management processing is started in a case where the user terminal 103 accepts predetermined operation by the user, for example, in a case where a user is newly registered in the user data 111a, in a case where the user data 111a of an already registered user is changed, or the like. A trigger for starting the user management processing is not limited thereto.

The registration unit 131 generates user information based on a user input (step S101).

For example, the user information includes information input by the user such as contact information. For example, in a case where a user is already registered, the user information further includes the user ID of the user.

The registration unit 131 transmits the user information generated in step S101 based on an instruction of the user (step S102).

The user management unit 112 acquires the user information transmitted in step S102 (step S103).

The user management unit 112 generates the user data 111a based on the user information acquired in step S103 (step S104).

For example, it is assumed that the user information includes contact information. In a case where a user is newly registered, the user management unit 112 automatically generates, for example, a user ID, and generates the user data 111a including the generated user ID and the acquired contact information. In a case where the user data 111a regarding the already-registered user is updated, the user management unit 112 generates the user data 111a including the acquired user ID and contact information.

The user management unit 112 stores the user data 111a generated in step S104 in the user storage unit 111 (step S105), and ends the user management processing. Accordingly, the user can be registered.

### Example of Use Schedule Management Processing According to First Example Embodiment

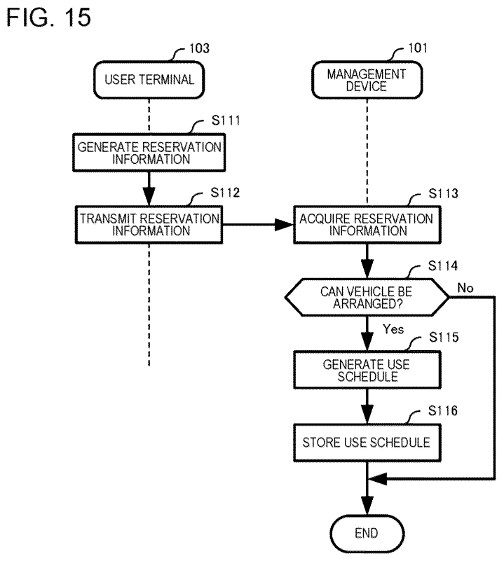

FIG. 15 is a view indicating an example of flow of the use schedule management processing according to the first example embodiment. The use schedule management processing is processing for managing the use schedule. The use schedule management processing is started, for example, when the user terminal 103 accepts predetermined operation by the user. A trigger for starting the use schedule management processing is not limited thereto.

The reservation unit 132 generates reservation information based on a user input (step S111).

For example, the reservation information may be any of reservation application information, reservation update information, and the like, and may include one or more of scheduled use time, a scheduled use place, and the like, that the user desires to use. The reservation information may include a vehicle type that the user desires to use. The vehicle type is, for example, a small car, a passenger car, a wagon, a truck, or the like.

The reservation unit 132 transmits the reservation information generated in step S111 based on an instruction of the user (step S112).

The use schedule management unit 114 acquires the reservation information transmitted in step S112 (step S113).

The use schedule management unit 114 determines whether a vehicle can be arranged based on desire of the user included in the reservation information acquired in step S113 (step S114).

For example, the use schedule management unit 114 determines whether a vehicle that meets the desire of the user can be arranged. Specifically, for example, the use schedule management unit 114 determines that a vehicle cannot be arranged in a case where there is no available vehicle due to previous reservation, or the like, at the scheduled use time and the scheduled use place desired by the user. For example, in a case where there is the vehicle C as a vehicle available at the scheduled use time and the scheduled use place desired by the user, it is determined that a vehicle can be arranged.

In a case where it is determined that a vehicle cannot be arranged (step S114: No), the use schedule management unit 114 ends the use schedule management processing. In a case where it is determined that a vehicle can be arranged (step S114: Yes), the use schedule management unit 114 generates use schedule data 113a based on the reservation information acquired in step S112 (step S115).

For example, in a case where the reservation application information is acquired in step S111, the use schedule management unit 114 automatically generates a schedule ID and generates the use schedule data 113a including the generated schedule ID. The use schedule data 113a further includes, for example, the user ID, the scheduled use time, and the scheduled use place included in the reservation application information, and the vehicle ID of the vehicle C that can be arranged.

For example, in a case where the reservation update information is acquired in step S111, the use schedule management unit 114 acquires the use schedule data 113a including the user ID, the schedule ID, and the like, included in reservation update information from the use schedule storage unit 113. The use schedule management unit 114 changes at least one of the scheduled use time, the scheduled use place, or the vehicle ID of the acquired use schedule data 113a according to the reservation update information, and generates the updated use schedule data 113a.

The use schedule management unit 114 stores the use schedule data 113a generated in step S115 in the use schedule storage unit 113 (step S116), and ends the use schedule management processing. As a result, the user can newly reserve the vehicle C according to the desire or update the reservation that has already been made to different content.

### Example of Use Start Processing According to First Example Embodiment

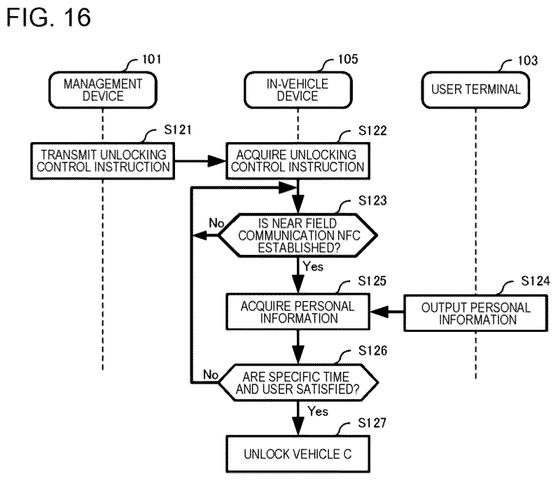

FIG. 16 is a view indicating an example of flow of the use start processing according to the first example embodiment. The use start processing is processing for starting use of the vehicle based on reservation of the user. The use start processing is started, for example, when it is time to transmit an unlocking control instruction according to the reservation of the vehicle. The time for transmitting the unlocking control instruction is, for example, a predetermined period (for example, ten minutes) before the latest scheduled use start time. A trigger for starting the use start processing is not limited thereto.

Hereinafter, the use start processing for the vehicle C reserved by a user UA based on the use schedule associated with a schedule ID “SCA” in the use schedule data 113a indicated in FIG. 8 will be described as an example.

The vehicle instruction unit 119 transmits the unlocking control instruction according to the reservation of the vehicle (step S121).

For example, the unlocking control instruction transmitted in step S121 is an instruction to allow the user UA (specific user) to unlock the vehicle C more than five minutes (specific period) before scheduled use start time “TAS”.

The unlocking control unit 152 acquires the unlocking control instruction transmitted in step S121 (step S122).

The unlocking control unit 152 determines whether the near field communication NFC is established between the user terminal 103 and the in-vehicle device 105 (step S123). In a case where the near field communication NFC is not established (step S123: No), the state becomes a standby state until the near field communication NFC is established.

If the near field communication NFC is established with the unlocking control unit 152 in response to predetermined operation by the user, the personal information output unit 133 outputs the personal information (step S124).

For example, the personal information output unit 133 performs operation for the user to output the personal information on the user terminal 103, and brings the user terminal 103 close to the in-vehicle device 105. As a result, the near field communication NFC is established between the user terminal 103 and the in-vehicle device 105.

In a case where the near field communication NFC is established (step S123: Yes), the unlocking control unit 152 acquires the personal information output in step S124 (step S125).

The unlocking control unit 152 determines whether time when the personal information is acquired in step S125 and the user indicated by the personal information satisfy the specific time and the user included in the unlocking control instruction acquired in step S122 (step S126).

In a case where both the time and the user satisfy the specific time and the user included in the unlocking control instruction, the unlocking control unit 152 determines that the specific time and the user are satisfied. The case where both the time and the user satisfy the specific time and the user included in the unlocking control instruction is, for example, a case where the time when the personal information was acquired is included in the specific time, and the user indicated by the personal information is a specific user. In a case where at least one of the time or the user does not satisfy the specific time or the user included in the unlocking control instruction, it is determined that the specific time and the user are not satisfied.

In a case where it is determined that the specific time and the user are not satisfied (step S126: No), the unlocking control unit 152 executes step S123 again. The processing of the unlocking control unit 152 may return to step S123 until the scheduled use start time “TAS” has passed, until the scheduled use start time “TAS” has passed a predetermined period (for example, ten minutes) or more, or until both the specific time and the user are satisfied. Then in a case where both the specific time and the user are not satisfied even after the scheduled use start time “TAS” has passed or the scheduled use start time “TAS” has passed a predetermined period (for example, ten minutes) or more, the unlocking control unit 152 may end the use start processing, for example.

In a case where it is determined that the specific time and the user are satisfied (step S126: Yes), the unlocking control unit 152 unlocks the reserved vehicle C as control of unlocking the vehicle (step S127), and ends the use start processing.

Thus, the unlocking control unit 152 can allow the user UA to unlock the vehicle C based on the scheduled use start time. Then, after the vehicle C is unlocked in step S127, the user UA can use the vehicle C using a key. For example, the user UA can cause the vehicle C to travel using the car navigation unit 156 as necessary. The user UA can unlock or lock the lock of the vehicle C using the key as necessary.

### Example of Use End Processing According to First Example Embodiment

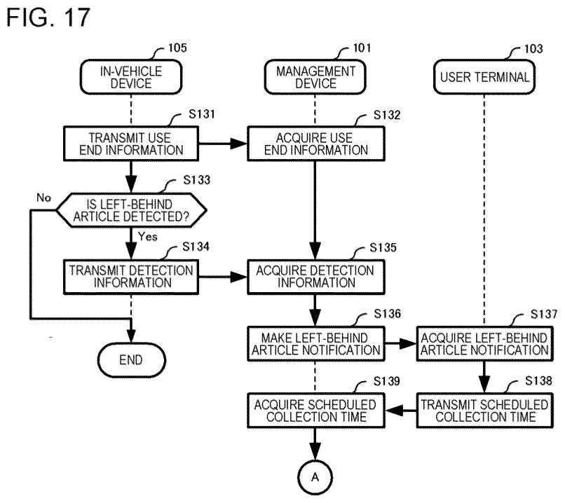

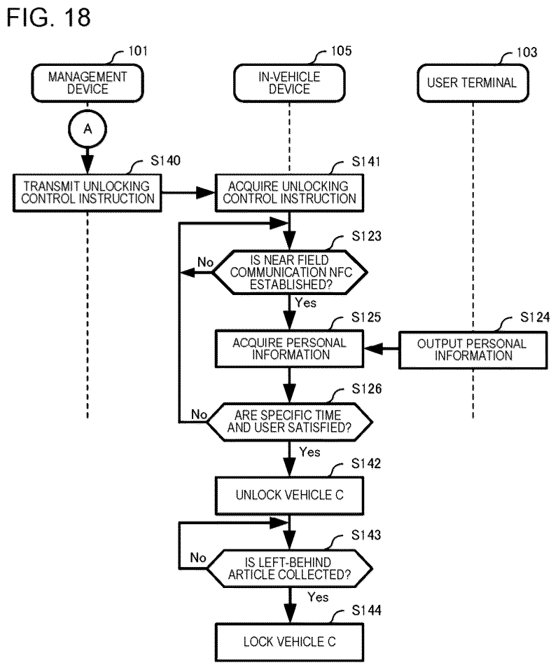

FIGS. 17 and 18 are views indicating an example of flow of the use end processing according to the first example embodiment. The use end processing is processing for ending use of the vehicle based on the reservation of the user. The use end processing is started, for example, when the use end detection unit 153 detects end of use of the vehicle and the unlocking control unit 152 locks the vehicle C. A trigger for starting the use end processing is not limited thereto.

Hereinafter, the use end processing for the vehicle C reserved by the user UA based on the use schedule associated with the schedule ID “SCA” in the use schedule data 113a indicated in FIG. 8 will be described as an example.

If the use end detection unit 153 detects end of use of the vehicle C, the end information transmission unit 154 transmits the use end information (step S131).

The end information acquisition unit 115 acquires the use end information transmitted in step S131 (step S132). In this event, the end information acquisition unit 115 may set “1” in the use end flag associated with the schedule ID “SCA” in the use schedule data 113a indicated in FIG. 8.

The left-behind article detection unit 151 determines whether a left-behind article is detected in the vehicle C (step S133). In a case where a left-behind article is not detected (step S133: No), the left-behind article detection unit 151 ends the use end processing.

In a case where a left-behind article is detected (step S133: Yes), the left-behind article detection unit 151 transmits detection information indicating that the left-behind article is detected in the vehicle C (step S134).

The detection information acquisition unit 116 acquires the detection information transmitted in step S134 (step S135).

In response to the acquisition of the detection information in step S135, the left-behind article notification unit 117 makes a left-behind article notification indicating that there is the left-behind article in the vehicle C (step S136).

For example, the left-behind article notification unit 117 refers to the user data 111a to specify the contact information of the user UA who has most recently used the vehicle C in which the left-behind article is detected. The left-behind article notification unit 117 makes a notification to the specified contact information. In a case where the contact information is a phone number, the left-behind article notification unit 117 makes a notification of a phone call using an automatic speech, for example. This enables the left-behind article notification unit 117 to make a left-behind article notification in a case where the use end information is acquired and the left-behind article is detected. The left-behind article notification is not limited to a notification using a phone call, and may be a notification using an e-mail to the user's e-mail address, a notification to an SNS used by the user, or a notification using any other method.

The left-behind article notification acquisition unit 134 acquires the left-behind article notification made in step S136 (step S137).

For example, in a case where the left-behind article notification is a phone call, the left-behind article notification acquisition unit 134 acquires the left-behind article notification when the user UA receives the phone call. As a result, the user UA can know that the user UA has left an article behind in the vehicle C by the automatic speech.

The collection schedule notification unit 135 transmits the scheduled collection time based on an input by the user UA in response to the left-behind article notification acquired in step S137 (step S138).

For example, in a case where the left-behind article notification is a phone call, the user UA inputs the scheduled collection time using a numeric input key, or the like, according to an automatic speech. The numeric input key may be provided in a general telephone function for inputting a phone number, for example. The collection schedule notification unit 135 transmits the scheduled collection time input by the user UA.

The collection schedule acquisition unit 118 acquires the scheduled collection time transmitted in step S138 (step S139).

The vehicle instruction unit 119 transmits an unlocking control instruction in accordance with collection of the left-behind article based on the scheduled collection time acquired in step S139 (step S140).

For example, the unlocking control instruction transmitted in step S140 is an instruction to allow the user UA (specific user) who has left behind an article to unlock the vehicle C a predetermined period that is five minutes (specific period) or more before the scheduled collection time.

The unlocking control unit 152 acquires the unlocking control instruction transmitted in step S140 (step S141).

Subsequently, processing similar to step S123 to S126 described above is executed.

In a case where it is determined that the specific time and the user are not satisfied (step S126: No), the unlocking control unit 152 executes step S123 again. The processing of the unlocking control unit 152 may return to step S123 until the scheduled collection time has passed or the scheduled collection time has passed a predetermined period (for example, ten minutes) or more, or until both the specific time and the user are satisfied. In a case where both the specific time and the user are not satisfied even after the scheduled collection time has passed or the scheduled collection time has passed a predetermined period (for example, ten minutes) or more, the unlocking control unit 152 may end the use end processing, for example.

In a case where it is determined that the specific time and the user are satisfied (step S126: Yes), the unlocking control unit 152 unlocks the vehicle C in which the left-behind article is detected (step S142).

Thus, the unlocking control unit 152 can allow the user UA to unlock the vehicle C based on the scheduled collection time.

The collection detection unit 155 determines whether the left-behind article in the vehicle C is collected (step S143). In a case where collection of the left-behind article is not detected (step S143: No), the collection detection unit 155 the collection detection unit 155 repeatedly executes step S143 and waits until the left-behind article in the vehicle C is collected.

As described above, the vehicle C is unlocked until collection of the left-behind article is detected, and thus, the user UA can collect the left-behind article in the vehicle C.

In a case where collection of the left-behind article is detected (step S143: Yes), the unlocking control unit 152 locks the vehicle C (step S144). As a result, the unlocking control unit 152 prohibits unlocking of the vehicle C by all the users, and ends the use end processing.

### Operation and Effect

As described above, according to the present example embodiment, the management system 100 includes the end information acquisition unit 115, the left-behind article detection unit 151, the left-behind article notification unit 117, the collection schedule acquisition unit 118, and the unlocking control unit 152.

The end information acquisition unit 115 acquires use end information indicating that the user ends use of the vehicle. The left-behind article detection unit 151 detects a left-behind article in the vehicle. The left-behind article notification unit 117 make a left-behind article notification indicating that there is the left-behind article in a case where the use end information is acquired and the left-behind article is detected.

The collection schedule acquisition unit 118 acquires scheduled collection time indicating time when the user will return to a parking place of the vehicle to collect the left-behind article as a response to the left-behind article notification. The unlocking control unit 152 controls unlocking of the vehicle. The unlocking control of the vehicle includes allowing the user to unlock the vehicle based on the scheduled collection time.

As a result, in a case where an article is left behind in the vehicle, the user is allowed to unlock the vehicle at the scheduled collection time, so that the user can easily directly collect the left-behind article from the vehicle. It is possible to reduce trouble of going to a place where left-behind articles are collected, or the like, to take the left-behind article. Thus, in a case where an article is left behind in the vehicle, the user can easily collect the left-behind article.

### Second Example Embodiment

In the present example embodiment, in order to simplify the description, the description overlapping with the first example embodiment will be omitted as appropriate, and a configuration different from the first example embodiment will be mainly described.

The management system according to the second example embodiment includes a management device 201 and an in-vehicle device 205 instead of the management device 101 and the in-vehicle device 105 according to the first example embodiment, respectively.

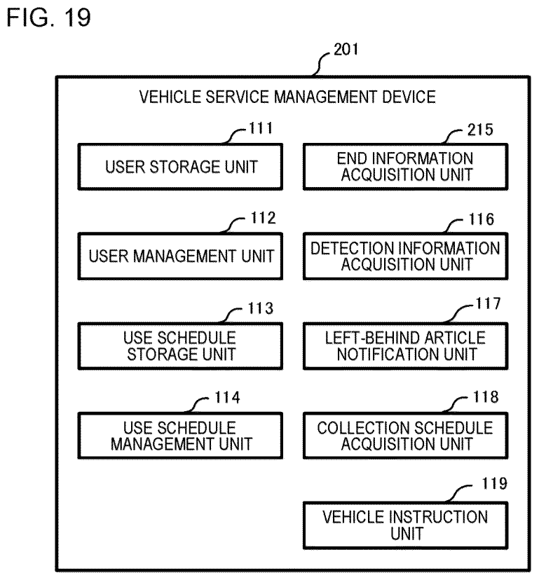

FIG. 19 is a view illustrating a functional configuration example of the management device 201 according to the second example embodiment. The management device 201 functionally includes, for example, an end information acquisition unit 215 in place of the end information acquisition unit 115 according to the first example embodiment.

In addition to the use end information similar to that of the first example embodiment, the end information acquisition unit 215 acquires a parking place of the vehicle that has been used. The end information acquisition unit 215 determines whether the acquired parking place is the scheduled return place of the vehicle that has been used.

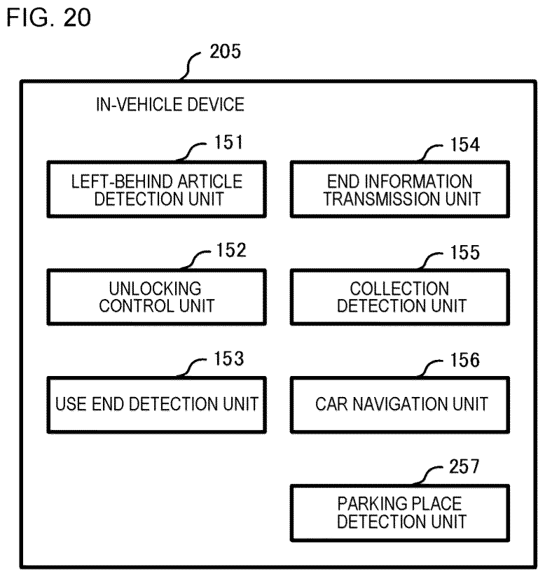

FIG. 20 is a view illustrating a functional configuration example of the in-vehicle device 205 according to the second example embodiment. The in-vehicle device 205 functionally further includes, for example, a parking place detection unit 257.

The parking place detection unit 257 detects the parking place of the vehicle in a case where the use of the vehicle ends and the vehicle is parked.

For example, if the user parks the vehicle, the parking place detection unit 257 detects a position of the parking place by using a function such as a global positioning system (GPS) or WiFi. The parking of the vehicle is, for example, stopping the vehicle and stopping operation of a drive source (for example, an engine and a motor) of the vehicle.

The configuration example of the management system according to the second example embodiment has been mainly described above. An operation example of the management system according to the second example embodiment will be described below.

The vehicle service management to be executed by the management system according to the second example embodiment includes use end processing partially different from that of the first example embodiment. In the present example embodiment, processing different from that in the first example embodiment among the processing included in the use end processing will be mainly described.

### Example of Use End Processing According to Second Example Embodiment

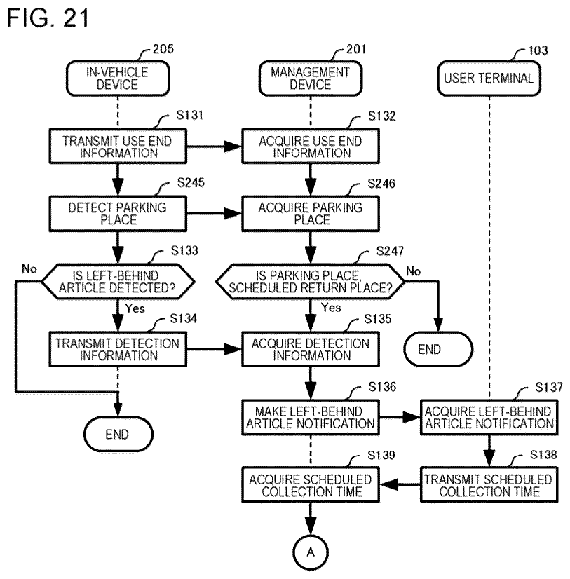

FIG. 21 is a view indicating an example of flow of the use end processing according to the second example embodiment. In the use end processing according to the second example embodiment, subsequent to step S131, the parking place detection unit 257 detects the parking place of the vehicle C (step S245), and transmits the detected parking place.

The end information acquisition unit 215 acquires the parking place detected in step S245 (step S246). The end information acquisition unit 215 determines whether the parking place acquired in step S246 is the scheduled return place of the vehicle C (step S247).

In a case where the parking place is not the scheduled return place of the vehicle C (step S247: No), the end information acquisition unit 215 ends the use end processing.

In a case where the parking place is the scheduled return place of the vehicle C (step S247: Yes), and if a left-behind article is detected in the vehicle C, step S135 similar to that in the first example embodiment is executed. In the present example embodiment, the end information acquisition unit 115 preferably sets “1” at the use end flag associated with the schedule ID “SCA” instead of step S132 being executed in a case where the parking place is the scheduled return place of the vehicle C (step S247: Yes).

Then, as in the first example embodiment, the left-behind article notification unit 117 makes a left-behind article notification indicating that there is the left-behind article in the vehicle C (step S136). Thus, in the present example embodiment, the left-behind article notification is transmitted in a case where the use end information is acquired, the left-behind article is detected, and the parking place is a predetermined place (for example, the return place).

### Operation and Effect

As described above, according to the present example embodiment, the management system includes the parking place detection unit 257. The parking place detection unit 257 detects the parking place of the vehicle in a case where the vehicle is parked. The left-behind article notification is made in a case where the use end information is acquired, the left-behind article is detected, and the parking place is the predetermined place.

As a result, in a case where the vehicle is parked in the parking place, the left-behind article notification is made. Thus, the user can easily directly collect the left-behind article from the vehicle by returning to the parking place to collect the left-behind article. Thus, in a case where an article is left behind in the vehicle, the user can easily collect the left-behind article.

### Third Example Embodiment

In the present example embodiment, an example in which different kinds of processing (left-behind article handling processing) are executed according to a predetermined condition in a case where a left-behind article is detected in the vehicle will be described. In the present example embodiment, in order to simplify the description, the description overlapping with the first example embodiment will be omitted as appropriate, and a configuration different from the first example embodiment will be mainly described.

The management system according to the third example embodiment includes a management device 301, a user terminal 103, and an in-vehicle device 105 in place of the management device 101, the user terminal 303, and the in-vehicle device 305 according to the first example embodiment, respectively.

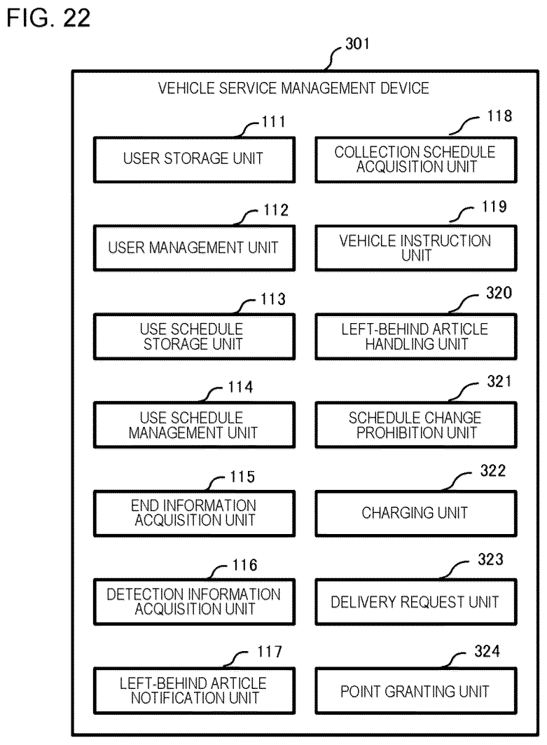

FIG. 22 is a view illustrating a functional configuration example of the management device 301 according to the third example embodiment. The management device 301 functionally further includes, for example, a left-behind article handling unit 320, a schedule change prohibition unit 321, a charging unit 322, a delivery request unit 323, and a point granting unit 324.

In a case where there is a left-behind article in the vehicle, the left-behind article handling unit 320 performs control to execute different kinds of left-behind article handling processing based on the next scheduled use start time and the scheduled collection time of the left-behind article.

The next scheduled use start time is the scheduled use start time of the next user. The next user is a user who is scheduled (that is, a user who has made reservation) to use the vehicle in which the left-behind article is left after the user who has left the article.

For example, the left-behind article handling unit 320 performs control to execute first left-behind article handling processing and second left-behind article handling processing which are different based on whether the scheduled collection time is before the next scheduled use start time. Details of the first left-behind article handling processing and the second left-behind article handling processing will be described later.

The left-behind article handling unit 320 may perform control so as to execute different kinds of left-behind article handling processing based on, for example, whether a time difference between the scheduled collection time and the next scheduled use start time is within a predetermined period.

The schedule change prohibition unit 321 prohibits change of the use schedule related to the vehicle. For example, the schedule change prohibition unit 321 prohibits the use schedule management unit 114 from changing the use schedule data 113a based on the reservation information. In a case where a predetermined condition is satisfied (for example, in a case where the left-behind article is collected), the schedule change prohibition unit 321 cancels prohibition of change of the use schedule.

The change of the use schedule prohibited by the schedule change prohibition unit 321 is change of the use schedule data 113a based on at least one of the reservation application information, the reservation update information, or the like. In other words, for example, the schedule change prohibition unit 321 prohibits one or both of new reservation based on the reservation information and change of the already reserved content based on the reservation update information.

The charging unit 322 determines a usage fee of the user. The usage fee is a fee for using the vehicle service.

For example, the charging unit 322 may determine an additional fee.

For example, the charging unit 322 may determine a charging condition for determining a fee for use of the vehicle. In this case, the charging unit 322 may determine the fee for use of the vehicle according to the charging condition. For example, in a case where the fee for the use of the vehicle is determined according to a use period of the vehicle, the charging condition is charging start time and charging end time. The charging start time is usually, for example, time when use of the vehicle is started. The charging end time is usually, for example, time when use of the vehicle ends.

In a case where there is a left-behind article in the vehicle, the delivery request unit 323 requests to deliver the left-behind article to a predetermined place. The predetermined place is, for example, a place where left-behind articles are collected (left-behind article collection place), and is specifically, for example, a police station, a police box, or the like, but is not limited thereto.

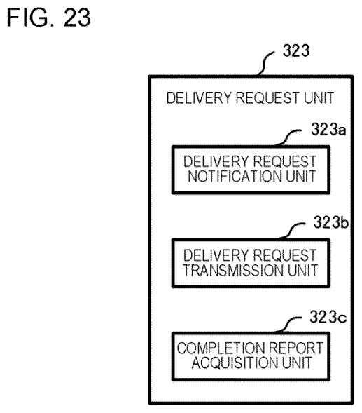

FIG. 23 is a view illustrating a functional configuration example of the delivery request unit 323 according to the third example embodiment. The delivery request unit 323 includes, for example, a delivery request notification unit 323a, a delivery request transmission unit 323b, and a completion report acquisition unit 323c.

The delivery request notification unit 323a notifies the next user of a first delivery request to deliver the left-behind article to the predetermined place. The first delivery request is information indicating a request to deliver the left-behind article to the predetermined place. For example, the delivery request notification unit 323a notifies the user terminal 103 of the first delivery request.

The delivery request transmission unit 323b transmits a second delivery request so as to present one or more candidate places for the predetermined place to the next user. The second delivery request is information indicating a request for presenting one or more candidate places for the predetermined place to the next user.

In a case where the next user delivers the left-behind article to the predetermined place, the completion report acquisition unit 323c acquires, from the next user, a completion report indicating completion of delivering the left-behind article.

Reference is made again to FIG. 23.

The point granting unit 324 determines a point to be granted to the user. For example, the point granting unit 324 determines a point to be granted to the user according to various predetermined conditions. The point is, for example, a point for giving a benefit that can be used in the vehicle service, or the like, to the user according to the accumulated amount, or the like. The point may be managed by the management device 301 by the management device 301 storing, for example, data including a current point.

For example, in a case where the completion report is acquired, the point granting unit 324 determines a point to be granted to the next user for delivering the left-behind article.

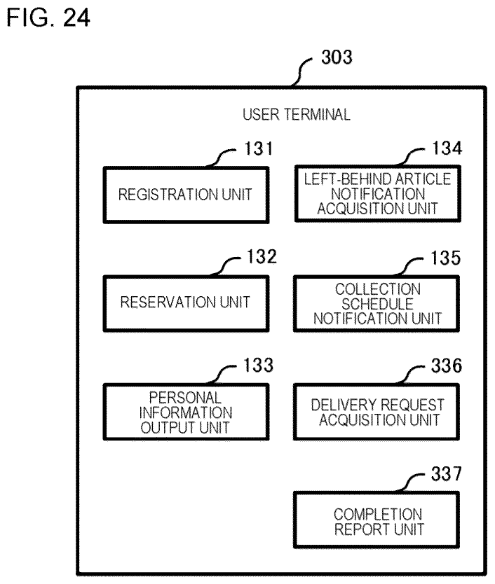

FIG. 24 is a view illustrating a functional configuration example of the user terminal 303 according to the third example embodiment. The user terminal 303 functionally includes, for example, a delivery request acquisition unit 336 and a completion report unit 337.

The delivery request acquisition unit 336 acquires the first delivery request. In response to the acquired first delivery request, the delivery request acquisition unit 336 notifies the user to deliver the left-behind article in the vehicle to the predetermined place.

The completion report unit 337 transmits the completion report based on, for example, predetermined operation by the user.

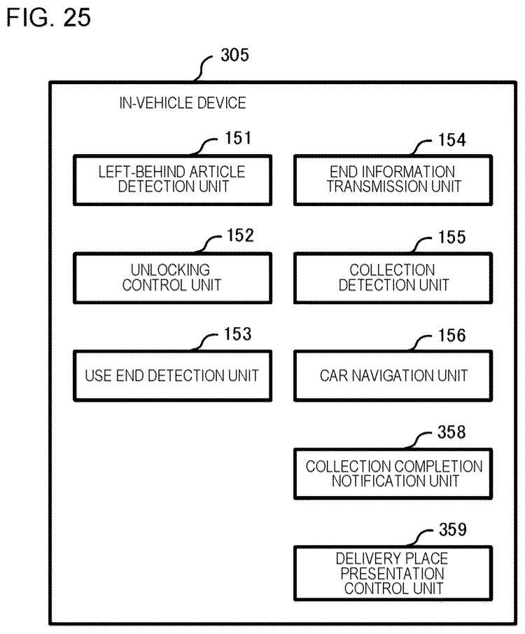

FIG. 25 is a view illustrating a functional configuration example of the in-vehicle device 305 according to third example embodiment. The in-vehicle device 305 functionally includes, for example, a collection completion notification unit 358 and a delivery place presentation control unit 359.

The collection completion notification unit 358 makes a collection completion notification. The collection completion notification is a notification indicating that the left-behind article in the vehicle is collected. For example, if the collection detection unit 155 detects collection of the left-behind article in the vehicle, the collection completion notification unit 358 makes a collection completion notification.

The delivery place presentation control unit 359 acquires the second delivery request. The delivery place presentation control unit 359 presents one or a plurality of candidate places for the predetermined place in response to the acquired second delivery request. The candidate places are, for example, a place where left-behind articles are collected (for example, a police station, a police box, and the like), and the like, close to a current position at the time of starting use of the vehicle in which the left-behind article is left.

The configuration example of the management system according to the second example embodiment has been mainly described above. An operation example of the management system according to the second example embodiment will be described below.

The vehicle service management to be executed by the management system according to the second example embodiment includes use end processing partially different from that of the first example embodiment. In the present example embodiment, processing different from that in the first example embodiment among the processing included in the use end processing will be mainly described.

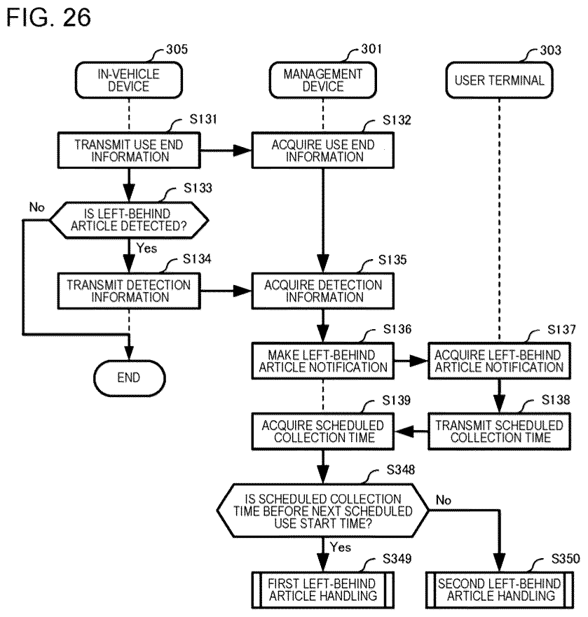

FIG. 26 is a view indicating an example of flow of the use end processing according to the third example embodiment.

Subsequent to step S139, the left-behind article handling unit 320 determines whether the scheduled collection time is before the next scheduled use start time (step S348).

In a case where the scheduled collection time is before the next scheduled use start time (step SS348: Yes), the left-behind article handling unit 320 performs control to execute the first left-behind article handling processing (step S349).

In a case where the scheduled collection time is not before the next scheduled use start time (step SS348: No), the left-behind article handling unit 320 performs control to execute the second left-behind article handling processing (step S350).

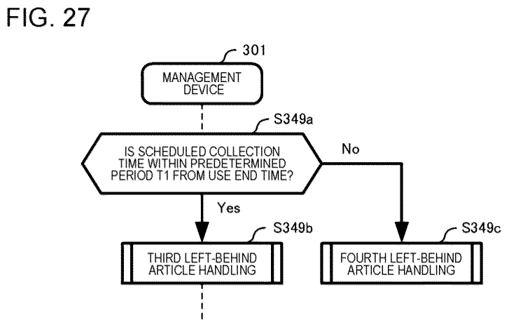

FIG. 27 is a view indicating an example of flow of the first left-behind article handling processing (step S349) according to the third example embodiment.

The left-behind article handling unit 320 determines whether the scheduled collection time is within a predetermined period T1 (for example, one hour) from the use end time (step S349a)

For example, the left-behind article handling unit 320 specifies the use end time based on the time when the use end information is acquired in step S132. The left-behind article handling unit 320 determines whether the scheduled collection time is within the predetermined period T1 from the use end time based on the specified use end time and the scheduled collection time acquired in step S139.

In a case where the scheduled collection time is within the predetermined period T1 from the use end time (step SS349a: Yes), the left-behind article handling unit 320 performs control to execute third left-behind article handling processing (step S349b).

In a case where the scheduled collection time is not within the predetermined period T1 from the use end time (step SS349a: No), the left-behind article handling unit 320 performs control to execute fourth left-behind article handling processing (step S349c).

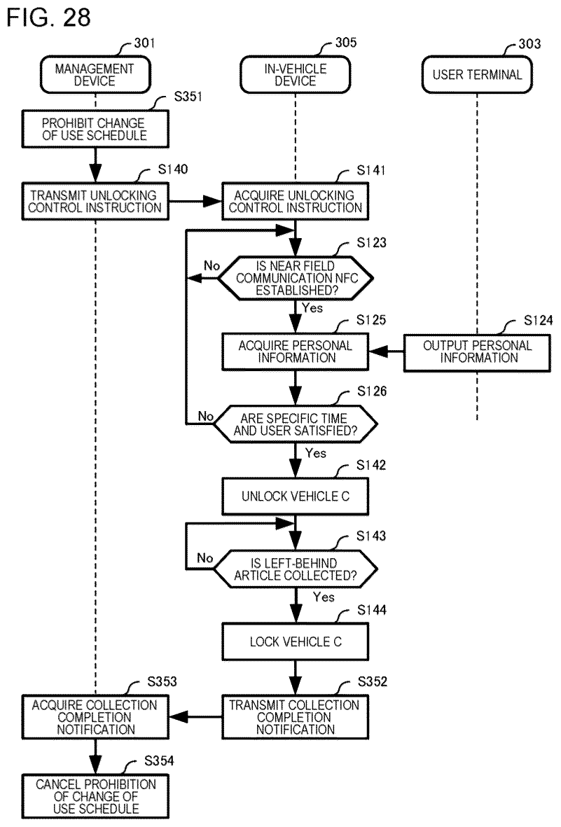

FIG. 28 is a view indicating an example of flow of the third left-behind article handling processing (step S349b) according to the third example embodiment.

The schedule change prohibition unit 321 prohibits change of the use schedule related to the vehicle (step S351). As a result, it is possible to prevent the vehicle from being used by the next user in a state where the left-behind article is left in the vehicle.

The vehicle for which change of the use schedule is to be prohibited is a vehicle in which the left-behind article is left.

Processing in step S140 and subsequent processing similar to those in the first example embodiment are performed. Subsequent to step S352, the collection completion notification unit 358 makes a collection completion notification (step S352).

The schedule change prohibition unit 321 acquires the collection completion notification transmitted in step S352 (step S353). The schedule change prohibition unit 321 cancels prohibition of change of the use schedule prohibited in step S351 (step S354). As a result, after the left-behind article in the vehicle is collected, the user can reserve and use the vehicle.

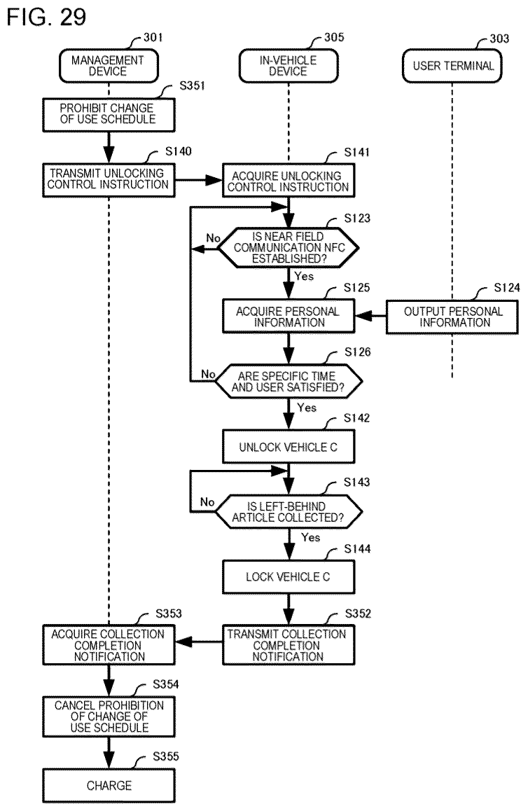

FIG. 29 is a view indicating an example of flow of the fourth left-behind article handling processing (step S349c) according to the third example embodiment. The fourth left-behind article handling processing (step S349c) includes step S355 in addition to the processing included in the third left-behind article handling processing (step S349b).

The charging unit 322 determines an additional fee associated with the prohibition of the change of the use schedule of the vehicle to collect the left-behind article (step S355).

A target of the additional fee is a user who has left the article behind in the vehicle. By this means, it is possible to reduce at least loss of a vehicle service provider that would have occurred due to the prohibition of the change of the use schedule of the vehicle over the predetermined period T1.

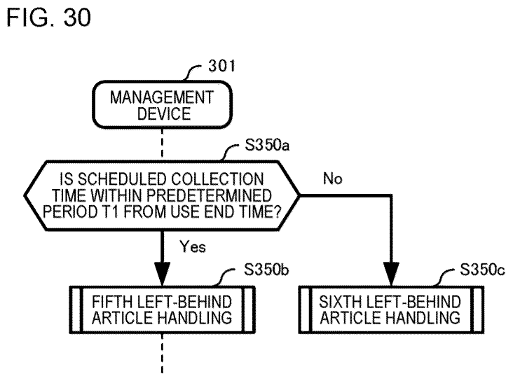

FIG. 30 is a view indicating an example of flow of the second left-behind article handling processing (step S350) according to the third example embodiment.

The left-behind article handling unit 320 determines whether the scheduled collection time is within a predetermined period T2 (for example, one hour) from the use end time (step S350a).

For example, the left-behind article handling unit 320 specifies the use end time based on the time when the use end information is acquired in step S132. The left-behind article handling unit 320 determines whether the scheduled collection time is within the predetermined period T2 from the use end time based on the specified use end time and the scheduled collection time acquired in step S139.

In a case where the scheduled collection time is within the predetermined period T2 from the use end time (step SS350a: Yes), the left-behind article handling unit 320 performs control to execute fifth left-behind article handling processing (step S350b).

In a case where the scheduled collection time is not within the predetermined period T2 from the use end time (step SS350a: No), the left-behind article handling unit 320 performs control to execute sixth left-behind article handling processing (step S350c).

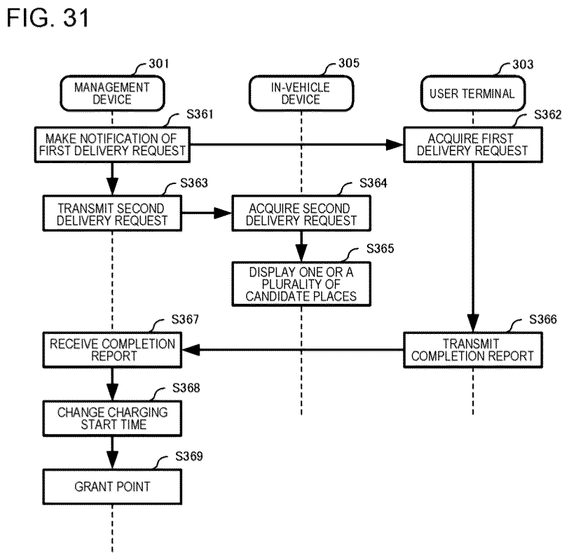

FIG. 31 is a view indicating an example of flow of the fifth left-behind article handling processing (step S350b) according to the third example embodiment.

The delivery request notification unit 323a notifies the user terminal 103 of the user (next user) who next uses the vehicle in which the left-behind article is left of the first delivery request (step S361). The delivery request acquisition unit 336 acquires the first delivery request notified in step S361 (step S362). This notification is preferably made using contact information of the next user included in the user data 111a. In a case where the contact information is a phone number, the notification is preferably made by an automatic speech, for example.

The delivery request transmission unit 323b transmits the second delivery request to the in-vehicle device 305 of the vehicle in which the left-behind article is left (step S363).

The delivery place presentation control unit 359 acquires the second delivery request transmitted in step S363 (step S364). The delivery place presentation control unit 359 causes, for example, the car navigation unit 156 to present one or more candidate places for the predetermined place (step S365).

As a result, the next user can deliver the left-behind article to a convenient police station, or the like, according to the guidance of the car navigation unit 156 using a map, a speech, or the like. The map in this case may indicate one or more candidate places, a route from the current position of the vehicle to the at least one or more candidate places, and the like.

If the next user completes delivery of the left-behind article, and the next user performs predetermined operation on the user terminal 103, the completion report unit 337 transmits a completion report (step S366).

The completion report acquisition unit 323c acquires the completion report transmitted in step S366 (step S367).

The charging unit 322 changes the charging start time (step S368). As a result, it is not charged for a period required for the next user to deliver the left-behind article. It is therefore possible to prompt the next user to deliver the left-behind article.

The point granting unit 324 grants a point corresponding to delivery of the left-behind article by the next user (step S369). As a result, it is possible to give a reward for delivering the left-behind article. It is therefore possible to prompt the next user to deliver the left-behind article, which improves a possibility that the left-behind article safely returns to the user.

The point granting unit 324 may determine a point to be granted to the next user for delivering the left-behind article in a case where a frequency at which the next user delivers the left-behind article in step S369 (the number of times of delivery within a predetermined period) is equal to or less than a predetermined value (for example, three times a month). There is a possibility that the user intentionally leaves an article by misusing provision of the point and obtains many points. By setting a limitation to the frequency, it is possible to reduce a risk of abuse of the point system for prompting delivery of the left-behind article.

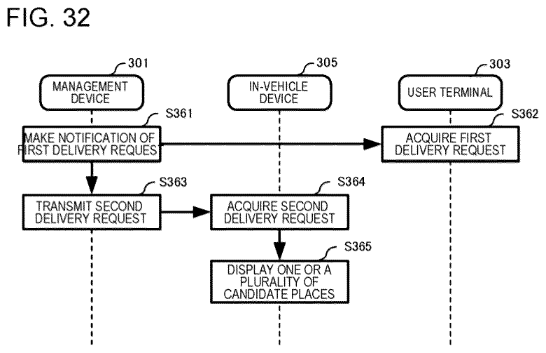

FIG. 32 is a view indicating an example of flow of the sixth left-behind article handling processing (step S350c) according to the third example embodiment. The sixth left-behind article handling processing is similar to the fifth left-behind article handling processing (step S350b) except that steps S366 to S369 are not included.

In a case where the sixth left-behind article handling processing (step S350c) is executed, a period longer than the predetermined period T2 has elapsed from the use end time.

Thus, in the sixth left-behind article handling processing (step S350c), a request for immediate delivery may be made in steps S361 and S363. In this case, for example, in step S362, the next user is preferably notified of a speech, or the like, to encourage the next user to deliver the left-behind article immediately. For example, in step S364, the car navigation unit 156 may be guided to deliver the left-behind article to the police station as close as possible (for example, the nearest) to the current position of the vehicle used by the next user.

### Operation and Effect

As described above, according to the present example embodiment, the management system includes the left-behind article handling unit 320. The left-behind article handling unit 320 performs control to execute different kinds of left-behind article handling processing based on the scheduled use start time of the next user who is scheduled to use the vehicle next and the scheduled collection time.

This makes it possible to execute different kinds of left-behind article handling processing based on the scheduled use start time of the next user and the scheduled collection time. Thus, a possibility of the user returning to take the left-behind article after the next user starts using the vehicle is reduced, and the user who has left the left-behind article can go to an appropriate place to collect the left-behind article. Thus, in a case where an article is left behind in the vehicle, the user can easily collect the left-behind article.

According to the present example embodiment, the management system includes the schedule change prohibition unit 321 that prohibits change of the use schedule related to the vehicle.

As a result, a possibility of the use schedule being changed and the user returning to take the left-behind article after the next user starts using the vehicle is reduced, and a possibility that the user who has left the left-behind article can directly collect the left-behind article from the vehicle is increased. Thus, in a case where an article is left behind in the vehicle, the user can easily collect the left-behind article.

According to the present example embodiment, prohibiting change of the use schedule is executed when the scheduled collection time is before the scheduled use start time of the next user who is scheduled to use the vehicle next.

As a result, a possibility of the use schedule being changed and the user returning to take the left-behind article after the next user starts using the vehicle is reduced, and a possibility that the user who has left the left-behind article can directly collect the left-behind article from the vehicle is increased. Thus, in a case where an article is left behind in the vehicle, the user can easily collect the left-behind article.

According to the present example embodiment, prohibition of change of the use schedule is canceled in a case where the left-behind article is collected.

As a result, after the left-behind article is collected from the vehicle, the vehicle can be provided for other users to use. It is therefore possible to reduce decrease in convenience of the vehicle service.

According to the present example embodiment, the management system includes the charging unit 322 that determines a usage fee of the user. Determining the usage fee includes determining an additional fee for the user based on collection time which is time when the left-behind article is collected.

By this means, it is also possible to reduce at least loss that has occurred due to the vehicle being unable to be used due to collection of the left-behind article. It is therefore possible for the user to easily collect the left-behind article while reducing the loss of the vehicle service provider.

According to the present example embodiment, the management system includes the delivery request unit 323 that requests the next user to deliver the left-behind article to the predetermined place.

As a result, even in a case where it is difficult for the user who has left an article behind in the vehicle to directly collect the left-behind article, it is possible to increase a possibility that the left-behind article is delivered to a safe place where a possibility of the left-behind article being stolen is low. Thus, a possibility of theft is reduced, and the user can reliably collect the left-behind article.

According to the present example embodiment, the delivery request unit 323 notifies the next user of the first delivery request indicating a request for delivering the left-behind article.

As a result, even in a case where it is difficult for the user who has left an article behind in the vehicle to directly collect the left-behind article, it is possible to increase a possibility that the left-behind article is delivered to a safe place where a possibility of the left-behind article being stolen is low. Thus, a possibility of theft is reduced, and the user can reliably collect the left-behind article.

According to the present example embodiment, the delivery request unit 323 transmits the second delivery request indicating a request for presenting one or more candidate places for the predetermined place to the next user.

As a result, even in a case where it is difficult for the user who has left an article behind in the vehicle to directly collect the left-behind article, it is possible to increase a possibility that the left-behind article is delivered to a safe place where a possibility of the left-behind article being stolen is low. Thus, a possibility of theft is reduced, and the user can reliably collect the left-behind article.

According to the present example embodiment, the delivery request unit 323 acquires the completion report indicating that the delivery of the left-behind article is completed from the next user. The management system further includes the point granting unit 324 that determines a point to be granted to the next user for delivering the left-behind article in a case where the completion report is acquired.

As a result, it is possible to prompt the next user to deliver the left-behind article by granting a point to the next user for delivering the left-behind article. Thus, even in a case where it is difficult for the user who has left an article behind in the vehicle to directly collect the left-behind article, it is possible to increase a possibility that the left-behind article is delivered to a safe place where a possibility of the left-behind article being stolen is low. Thus, a possibility of theft is reduced, and the user can reliably collect the left-behind article.

According to the present example embodiment, in determining the point, the point to be granted to the next user with respect to the delivery of the left-behind article is determined in a case where the number of times the next user delivers the left-behind article within a predetermined period is equal to or less than a predetermined value.

This can reduce a risk that a point system for prompting delivery of the left-behind article is abused. It is therefore possible for the user to easily collect the left-behind article while reducing the loss of the vehicle service provider.

### Fourth Example Embodiment

In the present example embodiment, even if the scheduled collection time is after the next scheduled use start time, if the user who has left an article behind in the vehicle can delay the next scheduled use start time, there is a possibility that the user can quickly collect the left-behind article. In the present example embodiment, an example will be described in which the fifth left-behind article processing includes processing for allowing the user who has left an article behind in the vehicle to contact the next user of the vehicle. In the present example embodiment, in order to simplify the description, the description overlapping with the third example embodiment will be omitted as appropriate, and a configuration different from that of the third example embodiment will be mainly described.

The management system according to the fourth example embodiment includes a management device 301 and a user terminal 303 instead of the management device 401 and the user terminal 403 according to the third example embodiment, respectively.

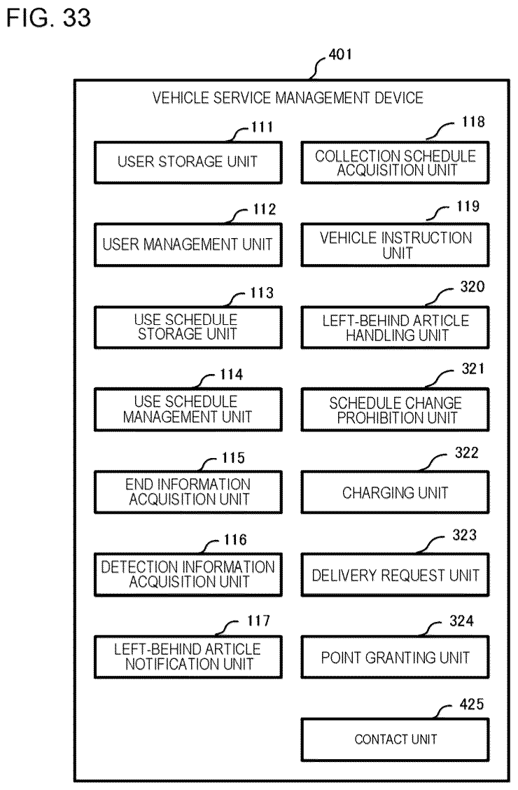

FIG. 33 is a view illustrating a functional configuration example of the management device 401 according to the fourth example embodiment. The management device 401 functionally further includes, for example, a contact unit 425.

The contact unit 425 performs contact processing. The contact processing is processing for allowing the user of the vehicle to contact the next user who is scheduled to use the vehicle next. The contact processing is executed, for example, in a case where the scheduled collection time is later than the scheduled use start time of the next user, but a condition for executing the contact processing is not limited thereto.

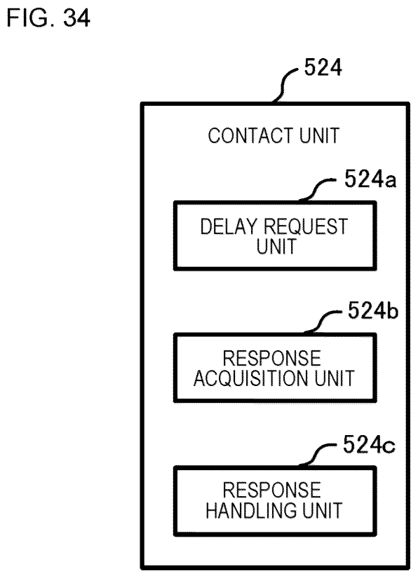

FIG. 34 is a view illustrating a functional configuration example of the contact unit 425 according to the fourth example embodiment. The contact unit 425 includes, for example, a delay request unit 425a, a response acquisition unit 425b, and a response handling unit 425c.

The delay request unit 425a notifies the next user of a delay request. The delay request is information indicating a request for delaying the scheduled use start time of the next user.

The response acquisition unit 425b acquires a response from the next user to the delay request.

The response handling unit 425c performs control to execute different kinds of response handling processing according to the response acquired by the response acquisition unit 425b. For example, the response handling unit 425c performs control to execute first response handling processing and second response handling processing which are different based on whether the next user accepts the delay request.

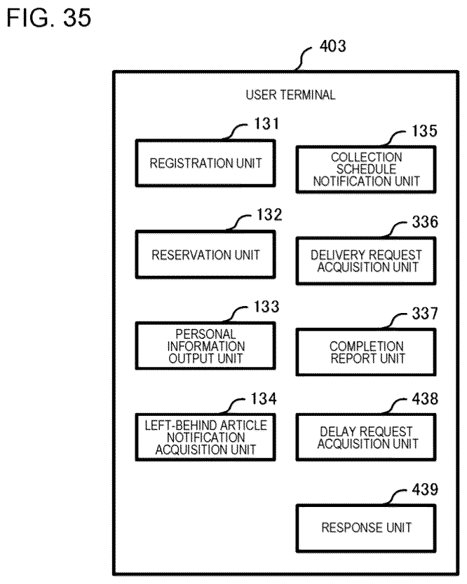

FIG. 35 is a view illustrating a functional configuration example of the user terminal 403 according to the fourth example embodiment. The user terminal 403 functionally includes, for example, a delay request acquisition unit 438 and a response unit 439.

The delay request acquisition unit 438 acquires the delay request. The response unit 439 transmits a response from the next user to the delay request acquired by the delay request acquisition unit 438.

The configuration example of the management system according to the fourth example embodiment has been mainly described above. An operation example of the management system according to the fourth example embodiment will be described below.

The vehicle service management to be executed by the management system according to the fourth example embodiment includes fifth left-behind article handling processing partially different from the fifth left-behind article handling processing (step S350b) according to the third example embodiment. In the present example embodiment, among the processing included in the use end processing, the fifth left-behind article handling processing will be mainly described with respect to portions different from those of the third example embodiment.

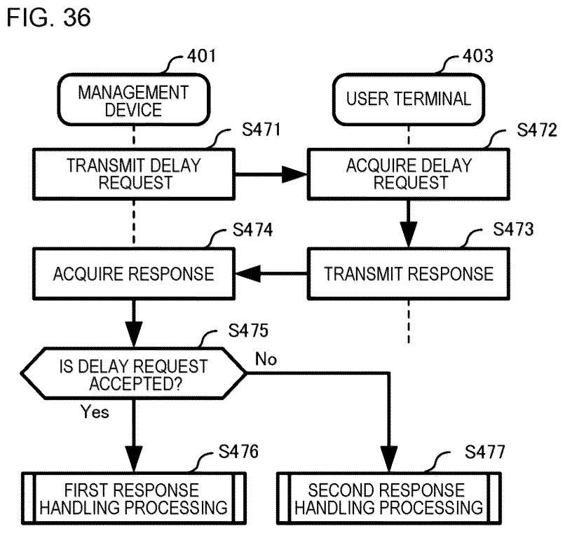

FIG. 36 is a view indicating an example of flow of the fifth left-behind article handling processing according to the fourth example embodiment.

The delay request unit 425a notifies the next user of the delay request (step S471). The delay request acquisition unit 438 acquires the delay request notified in step S471 (step S472). This notification is preferably made using contact information of the next user included in the user data 111a. In a case where the contact information is a phone number, the notification is preferably made by an automatic speech, for example.

The delay request may include, for example, delaying the scheduled use start time of the next user to time a predetermined period (for example, 15 minutes) after the scheduled collection time. The delay request may include, for example, time a predetermined period (for example, 15 minutes) after the scheduled collection time.

If the next user performs predetermined operation on the user terminal 103 in response to the delay request acquired in step S472, the response unit 439 transmits the response from the next user to the delay request (step S473).

For example, in a case where the delay request is notified by a phone call, the next user inputs a response using a numeric input key, or the like, according to an automatic speech. The numeric input key may be provided in a general telephone function for inputting a phone number, for example. The response unit 439 transmits the response input by the next user.

For example, the response may include whether to accept the delay request. In detail, for example, the response may include whether to accept delaying scheduled use start time of the next user to time the predetermined period after the scheduled collection time.

The response acquisition unit 425b acquires the response from the next user transmitted in step S473 (step S474).

The response handling unit 425c determines whether the next user accepts the delay request based on the response acquired in step S474 (step S475).

In a case where the delay request is accepted (step S475: Yes), the response handling unit 425c performs control to execute the first response handling processing (step S476). In a case where the delay request is not accepted (step S475: No), the response handling unit 425c performs control to execute the second response handling processing (step S477).

The second response handling processing (step S477) may be similar to, for example, the fifth left-behind article handling processing (step S350b) according to the third example embodiment (see FIG. 31). Thus, the first response handling processing (step S476) according to the present example embodiment will be described below with reference to the drawings.

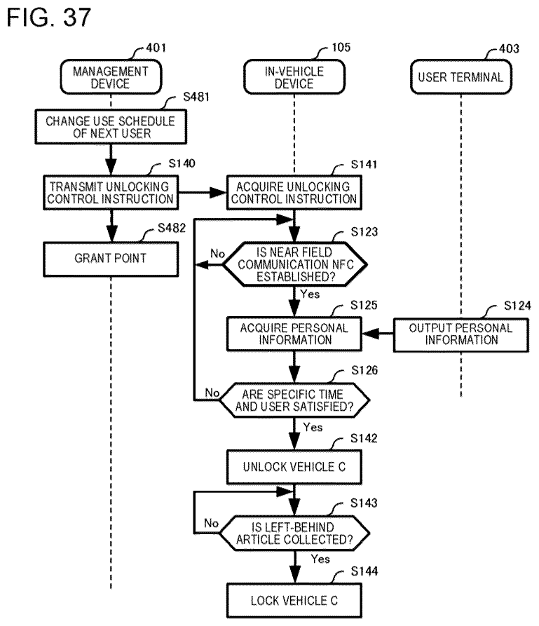

FIG. 37 is a view indicating an example of flow of the first response handling processing (step S476) according to the fourth example embodiment.

The use schedule management unit 114 changes the use schedule of the next user (step S481).

For example, the use schedule management unit 114 changes the scheduled use start time of the use schedule of the next user included in the use schedule data 113a to time a predetermined period (for example, 15 minutes) after the scheduled collection time.

In accordance with this change, in the control of unlocking the vehicle, control is performed in such a way that the next user is allowed to unlock the vehicle based on the changed scheduled use start time. The next user is allowed to unlock the vehicle, for example, from the changed scheduled use start time or a predetermined period (for example, five minutes) before the time.

In this manner, a predetermined time interval can be provided between the scheduled collection time and the scheduled use start time of the next user. This makes it possible to reduce a possibility that the user who has left the article behind in the vehicle and the next user of the vehicle come in contact with each other and a trouble occurs.

Step S140 is executed.

Subsequently, the point granting unit 324 grants a point for acceptance of the delay request by the next user (step S482).

As a result, a reward for accepting the delay request can be granted. Thus, the next user is prompted to accept the delay request, which can improve a possibility that the left-behind article safely returns to the user.

The point granting unit 324 may determine a point to be granted to the next user for accepting the delay request in a case where a frequency at which the next user accepts the delay request in step S372 (the number of times of delivery within a predetermined period) is equal to or less than a predetermined value (for example, three times a month). There is a possibility that the user intentionally leaves an article by misusing provision of the point and obtains many points. By setting a limitation to the frequency, it is possible to reduce a risk that the point system for prompting acceptance of the delay request is abused.

### Operation and Effect

As described above, according to the present example embodiment, the management system further includes the contact unit 425 that allows the user of the vehicle to contact the next user who is scheduled to use the vehicle next.

This allows the user who has left the article behind in the vehicle to contact the next user of the vehicle and adjust time to collect the left-behind article in the vehicle and time to start use of the vehicle by the next user. Thus, in a case where the user has left an article behind in the vehicle, it is possible for the user to easily collect the left-behind article while preventing decrease in convenience of other users.

According to the present example embodiment, the contact processing is performed in a case where the scheduled collection time is later than the scheduled use start time of the next user.

In such a case, if the user who has left an article behind in the vehicle goes to the vehicle to collect the left-behind article without contacting the next user, it is highly likely that the left-behind article cannot be collected even if the user returns to the vehicle because it is after the next user starts using the vehicle. Such a possibility can be reduced by performing the contact processing. As described above, it is possible to adjust the time to collect the left-behind article in the vehicle and the time to start use of the vehicle by the next user. Thus, in a case where the user has left an article behind in the vehicle, it is possible for the user to easily collect the left-behind article while preventing decrease in convenience of other users.

According to the present example embodiment, the contact unit 425 includes the delay request unit 425a, the response acquisition unit 425b, and the response handling unit 425c. The delay request unit 425a notifies the next user of a delay request for delaying the scheduled use start time of the next user. The response acquisition unit 425b acquires a response from the next user to the delay request. The response handling unit 425c performs control so as to execute different kinds of response handling processing according to the acquired response.

As a result, different kinds of response handling processing can be executed according to the response from the next user to the delay request. Thus, in a case where the user has left an article behind in the vehicle, it is possible for the user to easily collect the left-behind article while preventing decrease in convenience of other users.

According to the present example embodiment, the management system includes the use schedule management unit 114 that updates the use schedule related to the vehicle. Updating the use schedule includes changing the scheduled use start time of the next user to time a predetermined period after the scheduled collection time in a case where the response includes acceptance of the delay request. Controlling the unlocking of the vehicle includes controlling to allow the next user to unlock the vehicle based on the changed scheduled use start time.

This makes it possible to reduce a possibility that the user who has left the article behind in the vehicle and the next user of the vehicle come in contact with each other and a trouble occurs. Thus, in a case where the user has left an article behind in the vehicle, it is possible for the user to safely collect the left-behind article.

Although the example embodiments of the present invention and modifications have been described above with reference to the drawings, these are examples of the present invention, and various configurations other than the above can be adopted.

In the plurality of examples indicating flow of processing used in the above description, a plurality of steps (processing) is described in order, but the execution order of the steps executed in each example embodiment is not limited to the described order. In each example embodiment, the order of the illustrated steps can be changed as long as there is no problem in terms of content. The above-described example embodiments and modifications can be combined within a range in which the contents are not contradictory.

Some or all of the above example embodiments may be described as the following supplementary notes, but are not limited to the following.
1. A vehicle service management system including:
end information acquisition means for acquiring use end information indicating that a user ends use of a vehicle;
left-behind article detection means for detecting a left-behind article in the vehicle;
left-behind article notification means for making a left-behind article notification indicating that there is the left-behind article in a case where the use end information is acquired and the left-behind article is detected;
collection schedule acquisition means for acquiring scheduled collection time indicating time when the user will return to a parking place of the vehicle to collect the left-behind article as a response to the left-behind article notification; and
unlocking control means for controlling unlocking of the vehicle,
in which controlling unlocking of the vehicle includes allowing the user to unlock the vehicle based on the scheduled collection time.
2. The vehicle service management system according to 1, further including:
parking place detection means for detecting a parking place of the vehicle in a case where the vehicle is parked,
in which the left-behind article notification is made in a case where the use end information is acquired, the left-behind article is detected, and the parking place is a predetermined place.
3. The vehicle service management system according to 1 or 2 further including:
left-behind article handling means for performing control to execute different kinds of left-behind article handling processing based on scheduled use start time of a next user who is scheduled to use the vehicle next and the scheduled collection time.
4. The vehicle service management system according to any one of 1 to 3, further including:
schedule change prohibition means for prohibiting change of a use schedule related to the vehicle.
5. The vehicle service management system according to 4,
in which prohibiting the change of the use schedule is executed in a case where the scheduled collection time is before scheduled use start time of a next user who is scheduled to use the vehicle next.
6. The vehicle service management system according to 4 or 5,
in which prohibition of the change of the use schedule is canceled in a case where the left-behind article is collected.
7. The vehicle service management system according to any one of 4 to 6, further including:
charging management means for determining a usage fee of the user,
in which determining the usage fee includes determining an additional fee to the user based on collection time that is time when the left-behind article is collected.
8. The vehicle service management system according to any one of 1 to 7, further including:
contact means for performing contact processing for allowing the user of the vehicle to contact a next user who is scheduled to use the vehicle next.
9. The vehicle service management system according to 8,
in which the contact processing is performed in a case where the scheduled collection time is later than scheduled use start time of the next user.
10. The vehicle service management system according to 8 or 9, in which the contact means includes:
delay request means for notifying the next user of a delay request for delaying scheduled use start time of the next user;
response acquisition means for acquiring a response from the next user to the delay request; and
response handling means for performing control to execute different kinds of response handling processing according to the acquired response.
11. The vehicle service management system according to 10, further including:
use schedule management means for updating a use schedule related to the vehicle, in which
updating the use schedule includes changing the scheduled use start time of the next user to time a predetermined period after the scheduled collection time in a case where the response includes acceptance of the delay request, and
controlling the unlocking of the vehicle includes performing control to allow the next user to unlock the vehicle based on the changed scheduled use start time.
12. The vehicle service management system according to any one of 1 to 11, further including:
delivery request means for requesting the next user to deliver the left-behind article to a predetermined place.
13. The vehicle service management system according to 12, in which the delivery request means includes:
delivery request notification means for notifying the next user of a first delivery request indicating a request to deliver the left-behind article;
delivery place presentation control means for transmitting a second delivery request indicating a request for presenting one or a plurality of candidate places for the predetermined place to the next user; and
completion report acquisition means for acquiring from the next user, a completion report indicating that delivery of the left-behind article is completed, and
the vehicle service management system further includes point granting means for determining a point to be granted to the next user for delivering the left-behind article in a case where the completion report is acquired.
14. The vehicle service management system according to 13,
in which in determining the point, the point to be granted to the next user for delivering the left-behind article is determined in a case where the number of times the next user delivers a left-behind article within a predetermined period is equal to or less than a predetermined value.
15. A vehicle service management device including:
end information acquisition means for acquiring use end information indicating that a user ends use of a vehicle;
detection information acquisition means for acquiring detection information indicating that a left-behind article is detected in the vehicle;
left-behind article notification means for making a left-behind article notification indicating that there is the left-behind article in a case where the use end information is acquired and the detection information is acquired;
collection schedule acquisition means for acquiring scheduled collection time indicating time when the user will return to a parking place of the vehicle to collect the left-behind article as a response to the left-behind article notification; and
vehicle instruction means for transmitting an unlocking control instruction for controlling unlocking of the vehicle,
in which the unlocking control instruction includes an instruction for allowing the user to unlock the vehicle based on the scheduled collection time.
16. A vehicle service management method to be executed by one or more computers, the vehicle service management method including:
acquiring use end information indicating that a user ends use of a vehicle;
detecting a left-behind article in the vehicle;
making a left-behind article notification indicating that there is the left-behind article in a case where the use end information is acquired and the left-behind article is detected;
acquiring scheduled collection time indicating time when the user will return to a parking place of the vehicle to collect the left-behind article as a response to the left-behind article notification; and
controlling unlocking of the vehicle,
in which the controlling unlocking of the vehicle includes allowing the user to unlock the vehicle based on the scheduled collection time.
17. The vehicle service management method according to 16, further including:
detecting a parking place of the vehicle in a case where the vehicle is parked,
in which the left-behind article notification is made in a case where the use end information is acquired, the left-behind article is detected, and the parking place is a predetermined place.
18. The vehicle service management method according to 16 or 17, further including:
performing control to execute different kinds of left-behind article handling processing based on scheduled use start time of a next user who is scheduled to use the vehicle next and the scheduled collection time.
19. The vehicle service management method according to any one of 16 to 18, further including:
prohibiting change of a use schedule related to the vehicle.
20. The vehicle service management method according to 19,
in which the prohibiting the change of the use schedule is executed in a case where the scheduled collection time is before scheduled use start time of a next user who is scheduled to use the vehicle next.
21. The vehicle service management method according to 19 or 20,
in which prohibition of the change of the usage schedule is canceled in a case where the left-behind article is collected.
22. The vehicle service management method according to any one of 19 to 21, further including:
determining a usage fee of the user,
in which the determining the usage fee includes determining an additional fee to the user based on collection time that is time when the left-behind article is collected.
23. The vehicle service management method according to any one of 16 to 22, further including:
performing contact processing for allowing the user of the vehicle to contact a next user who is scheduled to use the vehicle next.
24. The vehicle service management method according to 23,
in which the contact processing is performed in a case where the scheduled collection time is later than scheduled use start time of the next user.
25. The vehicle service management method according to 23 or 24, in which
the contact processing includes:
notifying the next user of a delay request for delaying scheduled use start time of the next user;
acquiring a response from the next user to the delay request; and
performing control to execute different kinds of response handling processing according to the acquired response.
26. The vehicle service management method according to 25, further including:
updating a use schedule related to the vehicle, in which
the updating the use schedule includes changing the scheduled use start time of the next user to time a predetermined period after the scheduled collection time in a case where the response includes acceptance of the delay request, and
the controlling the unlocking of the vehicle includes performing control to allow the next user to unlock the vehicle based on the changed scheduled use start time.
27. The vehicle service management method according to any one of 16 to 26, further including:
requesting the next user to deliver the left-behind article to a predetermined place.
28. The vehicle service management method according to 27, in which
the requesting to deliver the left-behind article includes:
notifying the next user of a first delivery request indicating a request to deliver the left-behind article;
transmitting a second delivery request indicating a request for presenting one or a plurality of candidate places for the predetermined place to the next user; and
acquiring from the next user, a completion report indicating that delivery of the left-behind article is completed, and
the vehicle service management method further includes:
determining a point to be granted to the next user for delivering the left-behind article in a case where the completion report is acquired.
29. The vehicle service management method according to 28,
in which in determining the point, the point to be granted to the next user for delivering the left-behind article is determined in a case where the number of times the next user delivers a left-behind article within a predetermined period is equal to or less than a predetermined value.
30. A program for causing one or more computers to execute:
acquiring use end information indicating that a user ends use of a vehicle;
detecting a left-behind article in the vehicle;
making a left-behind article notification indicating that there is the left-behind article in a case where the use end information is acquired and the left-behind article is detected;
acquiring scheduled collection time indicating time when the user will return to a parking place of the vehicle to collect the left-behind article as a response to the left-behind article notification; and
controlling unlocking of the vehicle,
in which the controlling unlocking of the vehicle includes allowing the user to unlock the vehicle based on the scheduled collection time.
31. A program for causing one or more computers to execute the vehicle service management method according to any one of 17 to 29.
32. A recording medium recording a program for causing one or more computers to execute:
acquiring use end information indicating that a user ends use of a vehicle;
detecting a left-behind article in the vehicle;
making a left-behind article notification indicating that there is the left-behind article in a case where the use end information is acquired and the left-behind article is detected;
acquiring scheduled collection time indicating time when the user will return to a parking place of the vehicle to collect the left-behind article as a response to the left-behind article notification; and
controlling unlocking of the vehicle,
in which the controlling unlocking of the vehicle includes allowing the user to unlock the vehicle based on the scheduled collection time.
33. A recording medium recording a program causing one or more computers to execute the vehicle service management method according to any one of 17 to 29.

### REFERENCE SIGNS LIST

100 vehicle service management system (management system)
101, 201, 301, 401 vehicle service management device (management device)
103, 303, 403 user terminal
105, 205, 305 in-vehicle device
111 user storage unit
111a user data
112 user management unit
113 use schedule storage unit
113a use schedule data
114 use schedule management unit
114a schedule registration unit
115, 215 end information acquisition unit
116 detection information acquisition unit
117 left-behind article notification unit
118 collection schedule acquisition unit
119 vehicle instruction unit
131 registration unit
132 reservation unit
133 personal information output unit
134 left-behind article notification acquisition unit
135 collection schedule notification unit
151 left-behind article detection unit
152 unlocking control unit
153 use end detection unit
154 end information transmission unit
155 collection detection unit
156 car navigation unit
257 parking place detection unit
320 left-behind article handling unit
321 schedule change prohibition unit
322 charging unit
323 delivery request unit
323a delivery request notification unit
323b delivery request transmission unit
323c completion report acquisition unit
324 point granting unit
336 delivery request acquisition unit
337 completion report unit
358 collection completion notification unit
359 delivery place presentation control unit
425 contact unit
425a delay request unit
425b response acquisition unit
425c response handling unit
438 delay request acquisition unit
439 response unit

What is claimed is:

1. A vehicle service management system comprising:
a memory configured to store instructions; and
a processor configured to execute the instructions to:
acquire use end information indicating that a user ends use of a vehicle;
detect a left-behind article in the vehicle;
generate a left-behind article notification indicating that there is the left-behind article in a case where the use end information is acquired and the left-behind article is detected;
acquire scheduled collection time indicating time when the user will return to a parking place of the vehicle to collect the left-behind article as a response to the left-behind article notification; and
control unlocking of the vehicle,
wherein controlling unlocking of the vehicle includes allowing the user to unlock the vehicle based on the scheduled collection time.

2. The vehicle service management system according to claim 1, wherein the processor configured to further execute the instructions to:
detect a parking place of the vehicle in a case where the vehicle is parked,
wherein the left-behind article notification is made in a case where the use end information is acquired, the left-behind article is detected, and the parking place is a predetermined place.

3. The vehicle service management system according to claim 1, wherein the processor configured to further execute the instructions to:
perform control to execute different kinds of left-behind article handling processing based on scheduled use start time of a next user who is scheduled to use the vehicle next and the scheduled collection time.

4. The vehicle service management system according to claim 1, wherein the processor configured to further execute the instructions to:
prohibit change of a use schedule related to the vehicle.

5. The vehicle service management system according to claim 4,
wherein prohibiting the change of the use schedule is executed in a case where the scheduled collection time is before scheduled use start time of a next user who is scheduled to use the vehicle next.

6. The vehicle service management system according to claim 4,
wherein prohibition of the change of the use schedule is canceled in a case where the left-behind article is collected.

7. The vehicle service management system according to claim 4, wherein the processor configured to further execute the instructions to:
determine a usage fee of the user,
wherein determining the usage fee includes determining an additional fee to the user based on collection time that is time when the left-behind article is collected.

8. The vehicle service management system according to claim 1, wherein the processor configured to further execute the instructions to:
perform contact processing for allowing the user of the vehicle to contact a next user who is scheduled to use the vehicle next.

9. The vehicle service management system according to claim 8,
wherein the contact processing is performed in a case where the scheduled collection time is later than scheduled use start time of the next user.

10. The vehicle service management system according to claim 8, the contact processing includes:
notifying the next user of a delay request for delaying scheduled use start time of the next user;
acquiring a response from the next user to the delay request; and
performing control to execute different kinds of response handling processing according to the acquired response.

11. The vehicle service management system according to claim 10, wherein the processor configured to further execute the instructions to:
update a use schedule related to the vehicle, wherein
updating the use schedule includes changing the scheduled use start time of the next user to time a predetermined period after the scheduled collection time in a case where the response includes acceptance of the delay request, and
controlling the unlocking of the vehicle includes performing control to allow the next user to unlock the vehicle based on the changed scheduled use start time.

12. The vehicle service management system according to claim 1, wherein the processor configured to further execute the instructions to:
request the next user to deliver the left-behind article to a predetermined place.

13. The vehicle service management system according to claim 12, wherein
the requesting the next user to deliver the left-behind article includes:
notifying the next user of a first delivery request indicating a request to deliver the left-behind article;
transmitting a second delivery request indicating a request for presenting one or a plurality of candidate places for the predetermined place to the next user; and
acquiring from the next user, a completion report indicating that delivery of the left-behind article is completed, and
the processor configured to further execute the instructions to:
determine a point to be granted to the next user for delivering the left-behind article in a case where the completion report is acquired.

14. The vehicle service management system according to claim 13,
wherein in determining the point, the point to be granted to the next user for delivering the left-behind article is determined in a case where the number of times the next user delivers a left-behind article within a predetermined period is equal to or less than a predetermined value.

15. (canceled)

16. A vehicle service management method to be executed by one or more computers, the vehicle service management method comprising:
acquiring use end information indicating that a user ends use of a vehicle;
detecting a left-behind article in the vehicle;
making a left-behind article notification indicating that there is the left-behind article in a case where the use end information is acquired and the left-behind article is detected;
acquiring scheduled collection time indicating time when the user will return to a parking place of the vehicle to collect the left-behind article as a response to the left-behind article notification; and
controlling unlocking of the vehicle,
wherein the controlling unlocking of the vehicle includes allowing the user to unlock the vehicle based on the scheduled collection time.

17. A non-transitory computer readable medium recording a program for causing one or more computers to execute:
acquiring use end information indicating that a user ends use of a vehicle;
detecting a left-behind article in the vehicle;
making a left-behind article notification indicating that there is the left-behind article in a case where the use end information is acquired and the left-behind article is detected;
acquiring scheduled collection time indicating time when the user will return to a parking place of the vehicle to collect the left-behind article as a response to the left-behind article notification; and
controlling unlocking of the vehicle,
wherein the controlling unlocking of the vehicle includes allowing the user to unlock the vehicle based on the scheduled collection time.
